(19) United States
(12) Patent Application Publication
(10) Pub. No.: US 2021/0125428 A1
(43) Pub. Date: Apr. 29, 2021

(54) Apparatus and Method for Tire Separation Monitoring

(71) Applicants: Marcello Tedesco, Fort Gratiot, MI (US); Carl H. Schell, Waterford, MI (US); Lynn DaDeppo, Bloomfield, MI (US); Jeffrey T. Root, Howell, MI (US); Ehab Kamal, Oro Valley, AZ (US)

(72) Inventors: Marcello Tedesco, Fort Gratiot, MI (US); Carl H. Schell, Waterford, MI (US); Lynn DaDeppo, Bloomfield, MI (US); Jeffrey T. Root, Howell, MI (US); Ehab Kamal, Oro Valley, AZ (US)

(73) Assignee: Applied Mechatronic Products, LLC

(21) Appl. No.: 16/602,518

(22) Filed: Oct. 23, 2019

(51) Int. Cl. G07C 5/08; G06N 20/00; B60C 23/04; B60C 23/20; B60C 25/00

(52) U.S. Cl. CPC G07C 5/08; G06N 20/00; B60C 25/0554; B60C 23/20; B60C 25/007; B60C 23/0486

(57) ABSTRACT

A vehicle monitoring system monitors a vehicle characteristic and, from the monitoring, determines the state of a vehicle component. The system may set an alert and may communicate that alert to a user or supervisory authority. The state of the vehicle component may relate to a vehicle tire and to the potential delamination of a tire.

### RELATED APPLICATIONS

This application claims benefit of U.S. Provisional application entitled, VEHICLE MONITORING, ANALYSIS AND ADJUSTMENT SYSTEM,” Application No. 62/707,265, filed Oct. 26, 2017, and applications having the same inventorship as this application, filed on Oct. 25, 2018 as follows: “APPARATUS AND METHOD FOR VEHICLE WHEEL-END GENERATOR,” application Ser. No. 16/350,278; “APPARATUS AND METHOD FOR VEHICLE WHEEL-END FLUID PUMPING,” application Ser. No. 16/350,281; “APPARATUS AND METHOD FOR VEHICULAR MONITORING, ANALYSIS AND CONTROL,” application Ser. No. 16/350,285; “APPARATUS AND METHOD FOR VEHICULAR MONITORING ANALYSIS AND CONTROL OF WHEEL END SYSTEMS” application Ser. No. 16/350,273; and “APPARATUS AND METHOD FOR AUTOMATIC TIRE INFLATION SYSTEM,” application Ser. No. 16/350,283, the contents of which are hereby incorporated by reference in their entirety.

### BACKGROUND

Inventive concepts relate generally to a system and method for monitoring, recording, analyzing and alerting related to vehicle characteristics. In particular, inventive concepts relate to a system and method for monitoring and analyzing tire related parameters and conditions, such as delamination, and storing and/or transferring information related thereto.

Tire Pressure Monitoring Systems (TPMS) have been proposed as a means of monitoring tire pressure and advising an operator of the state of pressurization in a tire when the pressure is below a target pressure level. Typically, such monitoring systems merely provide an indication of tire pressure inflation level; they do not resolve a tire inflation issue. Although automatic tire inflation systems (ATIS) are available, these systems are costly and difficult to install, particularly for vehicles such as large trucks. Furthermore, no existing system provides tire status information.

Tire delamination is both costly and dangerous. By some estimates, tens of thousands of accidents occur and more than seven hundred people die each year due to tire-related accidents. A system and method in accordance with principles of inventive concepts is directed at reducing the millions of dollars in damages and hundreds of deaths due to tire-related accidents.

### SUMMARY OF THE INVENTION

In example embodiments in accordance with principles of inventive concepts a vehicle monitoring system may monitor a vehicle characteristic and, from the monitoring, may determine the state of a vehicle component. The system may set an alert and may communicate that alert to a user or supervisory authority. The state of the vehicle component may relate to a vehicle tire and to the potential delamination of a tire.

In example embodiments, a system for monitoring vehicle performance may include a sensor configured to sense a characteristic of a vehicle to produce data related to the characteristic; and a controller to collect and analyze data related to the characteristic of the vehicle, wherein the controller is configured to employ machine learning in the analysis of the data related to the characteristic of the vehicle.

In example embodiments a system may include a controller to develop and store a library of classifiers related to a vehicle characteristic.

In example embodiments a system may include a sensor to monitor a vehicle characteristic related to a vehicle tire.

In example embodiments a system may monitor the pressure of a vehicle tire.

In example embodiments a system may monitor the pressure of a vehicle tire.

In example embodiments a system may monitor the acceleration of a wheel-end associated with a vehicle.

In example embodiments the system includes at least one optical sensor.

In example embodiments a controller is configured analyze the sensor data and to make a determination regarding the potential delamination of a vehicle tire.

In example embodiments a controller is configured to produce an alert related to the potential delamination of a vehicle tire.

In example embodiments a controller is configured to transmit an alert related to the potential delamination of a vehicle tire.

In example embodiments a method includes a sensor sensing a characteristic of a vehicle to produce data related to the characteristic; and a controller collecting and analyzing data related to the characteristic of the vehicle, wherein the controller employs machine learning in the analysis of the data related to the characteristic of the vehicle.

In example embodiments a method includes a controller developing and storing a library of classifiers related to a vehicle characteristic.

In example embodiments a method includes monitoring a vehicle characteristic related to a vehicle tire.

In example embodiments a method includes monitoring tire pressure.

In example embodiments a method includes monitoring tire temperature.

In example embodiments a method includes monitoring acceleration of a wheel-end associated with the vehicle.

In example embodiments a method includes acquiring data from at least one optical sensor.

In example embodiments a method includes a controller analyzing sensor data and making a determination regarding the potential delamination of a vehicle tire.

In example embodiments a method includes a controller producing an alert related to the potential delamination of a vehicle tire.

In example embodiments a method includes a controller transmitting an alert related to the potential delamination of a vehicle tire.

### BRIEF DESCRIPTION OF THE DRAWINGS

Example embodiments in accordance with principles of inventive concepts will be more clearly understood from the following detailed description taken in conjunction with the accompanying drawings in which:

FIG. 1 is a block diagram of an example embodiment of an electronic system that may employ one or more vehicle monitoring, analysis, and control systems in accordance with principles of inventive concepts;

FIG. 2 is a block diagram of an example embodiment of a vehicle monitoring, analysis, and control system in accordance with principles of inventive concepts;

FIGS. 3-4B are views of example embodiments of vehicle monitoring, analysis and control systems installed on vehicles;

FIG. 5 is a block diagram of an example embodiment of electrical elements of a vehicle monitoring, analysis, and control system

FIG. 6 is a more detailed block diagram of an example embodiment of electrical elements of a vehicle monitoring, analysis, and control system;

FIG. 7 is a flow chart of an example embodiment of training a classifier for use in a vehicle monitoring, analysis and control system;

FIG. 8 is flow chart of a an example embodiment of a process of developing one or more classifiers for a classifier library;

FIG. 9 is a perspective view of a tire delamination event;

FIG. 10 is a side view of a tire delamination event;

FIG. 11 is a plot of axle tramp versus measured speed;

FIG. 12 is a flow chart of a monitoring process in accordance with principles of inventive concepts

FIG. 13 is a plot of amplitude versus signal duration of acceleration that may be indicative of a delamination event; and

FIGS. 14a and 14b are time versus amplitude plots of tire displacement for fault free and faulty tires, respectively;

FIGS. 15a and 15b are three axis acceleration versus time and the same data converted to frequency versus time plots, respectively;

FIG. 16 is a plot that demonstrates the windowing of a spectrogram into a plurality of smaller plots;

FIG. 17 is a time domain plot of three axis acceleration signals for a tire;

FIG. 18 a, b, and c are extracted time domain signals from the time domain plot of FIG. 17;

FIG. 19 a, b, and c are extracted frequency domain plots from the time domain plots of FIG. 18 a, b, and c; and

FIG. 20 a, b, and c are spectrograms of the frequency domain plots of FIG. 19a, b and c.

### DETAILED DESCRIPTION

Example embodiments in accordance with principles of inventive concepts will now be described more fully with reference to the accompanying drawings, in which example embodiments are shown. Example embodiments in accordance with principles of inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. Like reference numerals in the drawings denote like elements, and thus their description may not be repeated. Example embodiments of systems and methods in accordance with principles of inventive concepts will be described in reference to the accompanying drawings and, although the phrase “example embodiments in accordance with principles of inventive concepts” may be used occasionally, for clarity and brevity of discussion example embodiments may also be referred to as “Applicants' system,” “the system,” “Applicants' method,” “the method,” or, simply, as a named component or element of a system or method, with the understanding that all are merely example embodiments of inventive concepts in accordance with principles of inventive concepts.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “or” includes any and all combinations of one or more of the associated listed items. Other words used to describe the relationship between elements should be interpreted in a like fashion (for example, “between” versus “directly between,” “adjacent” versus “directly adjacent,” “on” versus “directly on”). The word “or” is used in an inclusive sense, unless otherwise indicated.

It will be understood that, although the terms “first”, “second”, etc. may be used herein to describe various elements, components, regions, layers or sections, these elements, components, regions, layers or sections should not be limited by these terms. These terms are only used to distinguish one element, component, region, step, layer or section from another element, component, region, step, layer or section. Thus, a first element, component, region, step, layer or section discussed below could be termed a second element, component, region, step, layer or section without departing from the teachings of example embodiments.

Spatially relative terms, such as “beneath,” “below,” “lower,” “above,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if an element in the figures is turned over, elements described as “bottom,” “below,” “lower,” or “beneath” other elements or features would then be oriented “atop,” or “above,” the other elements or features. Thus, the example terms “bottom,” or “below” can encompass both an orientation of above and below, top and bottom. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” or “including,” if used herein, specify the presence of stated features, integers, steps, operations, elements or components, but do not preclude the presence or addition of one or more other features, integers, steps, operations, elements, components or groups thereof. The word “or” is used in an inclusive sense to mean both “or” and “and/or.” The term “exclusive or” will be used to indicate that only one thing or another, not both, is being referred to.

Unless otherwise defined, all terms (including technical and scientific terms) used herein have the same meaning as commonly understood by one of ordinary skill in the art to which example embodiments in accordance with principles of inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

For clarity and brevity of description, inventive concepts may be described in terms of example embodiments related to large trucks. Although the following example embodiments focus on examples within the realm of large trucks, other wheeled vehicles, such as off-road vehicles, lift-trucks, industrial trucks, mining vehicles, automobiles, buses, in fact, any wheeled vehicle, are contemplated within the scope of inventive concepts.

The terms first, second, third, etc. may be used herein to describe various elements, components, regions, layers or sections. These elements, components, regions, layers or sections should not be limited by these terms. These terms may be only used to distinguish one element, component, region, step, layer or section from another region, step, layer or section. Terms such as “first,” “second,” and other numerical terms do not imply a sequence or order unless clearly indicated by the context. Thus, a first element, component, region, step, layer or section discussed below could be termed a second element, component, region, step, layer or section without departing from the teachings of the example configurations.

In example embodiments in accordance with principles of inventive concepts, a system and method in accordance with principles of inventive concepts may dynamically senses tire or wheel characteristics to detect tire spread separation and other tire sub-surface flaws. The system and method may record, analyze and report issues, or potential issues, to improve tire operational life and to avoid failures that could result in costly damages, injuries, or even deaths.

A system and method for sensing, analyzing, storing, and communicating data related to tire performance may determine that a tire failure or flaw, such as delamination, may be likely to occur and alert a user, such as a driver, dispatcher, or maintenance personnel, thereby allowing a user to carry out prophylactic measures to prevent costly and potentially fatal failures such as tire delamination. A tire is deformed at the ground contact patch as the tire rolls during motion of the vehicle. The tire flexes as the contact patch propagates around the circumference of the tire with rotation. During the flexing of the tire, the tire may experience high shear forces between interfacing component members internal to the tire. This shearing may be exacerbated for a variety of reasons, including: under-inflated tires, excessive loading of the tire for a given pressure, manufacturing anomalies (e.g. ply adhesion, vulcanization, corrosion/improper cleaning, compounding variation, etc.), or excess heating of the tire, for example. As a result of such conditions, the plies of the tire may begin to deteriorate in a manner that may result in an initiation of tire delamination. The delamination may begin as a separation of the ply containing the steel cords from the carcass. Subsequent to the delamination onset, two failure mechanisms may ensue. First (which may be referred to herein as a first type of delamination), the delamination may continue, progressing around the tire. Second (which may be referred to herein as a second type of delamination), and possibly concurrently, the flexing of the segment of the delaminated portion of the ply, resulting in fatiguing of the ply section. With both failure methods underway, the resulting separation of the ply from the carcass may occur as either a complete delamination without complete fatigue of the ply, (separation of the tire ply may maintain a circular shape); or the fatiguing of the ply, followed by continued delamination of the carcass, which typically results in ply strips being flung from the vehicle (along with attendant dangers).

In example embodiments a system and method in accordance with principles of inventive concepts may assess the possibility of the onset and/or propagation of a delamination by detecting and analyzing the variation of movement and other sensed characteristics of a tire. These sensed characteristics may be used to determine the degree of failure (for example, delamination) and the time of failure migration. In example embodiments data from triaxial accelerometers, (and/or, possibly, other sensors which may disclose the time/acceleration signature associated with an angle of delamination, for example) may be used to develop a learning process (to train a classifier, for example) to refine the process of recognizing the onset of tire failures. As a system and method in accordance with principles of inventive concepts continues to gather and analyze data, the system may define the time for propagation, given a set of pressure/temperature parameters. The delamination may, for example, start prior to separation; ply-to-carcass delamination may begin and, as the delamination increases, the ply may fold toward itself and may cause a fatiguing of the ply cords. This fatiguing action may eventually result in the separation of first individual cords and then may propagate to the beginning of separation to the entire ply layer from the carcass. Once the ply layer begins to leave the carcass, the ply layer will continue with each revolution to delaminate and separate completely, causing damage and potential injury in its wake. In example embodiments in accordance with principles of inventive concepts, this propagation of damage will be detected as the vehicle proceeds and the tire continues to rotate. Once the ply layer begins to leave the tire carcass, tire separation typically occurs within 0.5 to 4 seconds, depending upon the speed of the vehicle.

In example embodiments, a system and method in accordance with principles of inventive concepts may monitor tire characteristics using one or more sensors, such as accelerometers (three-axis accelerometers, for example), pressure sensors, temperature sensors, video (visible, ultraviolet, or infrared, for example) sensors, or audio sensors, for example, and analyze data from the sensors to detect potential failures and alert a user to the prospect of such a failure. In example embodiments, various levels of alerts may be set, according to the degree of imminence and/or the degree of seriousness of the potential failure. For example, a potential failure with a low level of probability of occurring within a predetermined period of time or distance may be included in a routine maintenance report, while a potential failure with a higher level of probability of occurring within that predetermined period may be included in a driver's end-of-shift report, or, in a case where the probability is even higher, an alert may be transmitted immediately, to a driver, to a supervisory entity, or to all.

In example embodiments one or more classifiers may be trained using tire characteristic data from one or more sensors. If multiple classifiers are trained, they may be trained to provide an indication of the degree to which tire delamination has taken place and “live” signals from an active vehicle may be compared against the one or more trained classifiers to determine the probability of failure (for example, delamination) within a given period (the “period” may be expressed as time, or distance, for example). The probability may take into account various driving conditions, such as velocity, load, or road surface quality, for example, in addition to sensor data such as pressure or temperature data, for example. For example, a system in accordance with principles of inventive concepts may classify a given tire in any of n classifications, with n=10 in this example. In such an example, classifications would include: 0% delamination signal detection; 10% delamination-onset signal detection (which may be interpreted as 400 miles to failure), 20% delamination-onset signal detection (which may be interpreted as 360 miles to delamination), 30% delamination-onset signal detection, etc., . . . up to 100% delamination-onset signal detection (which may be interpreted as delamination, with active tread separation, imminent).

A degree of certainty may be assigned to such a determination, as well, and may be assigned to, or associated with, a failure alert for the tire may also be used as a factor in assigning the level of alert that may be set. For example, acceleration data analysis may indicate a classification of 90% delamination-onset signal detection (which may be interpreted as, for example, 40 miles to failure) with a certainty of 98%. With a period of only forty miles to failure and a 98% degree of certainty, the level of alert may be set to the highest level, with attendant immediate notifications to a driver and/or supervising entity. On the other hand, with a classification of 10% (which may be interpreted as, for example 400 miles to failure) and a certainty of only 50%, the level of alert may be set at a lower level, merely including the analytical results in a maintenance log, for example.

In example embodiments acceleration and angular rotation and perturbations of a tire may be measured and analyzed over time by a controller that may be located in a wheel end assembly to determine whether a tire is undergoing incipient structural changes that could lead to a tire tread separation or other structural flaws. A continuous acceleration and angular rotational signal data stream may be employed by the controller for analysis and, should a structural condition of concern be detected, an alert may be provided to a user, such as a driver, a dispatcher, or maintenance personnel. The controller may employ pattern recognition, for example, for analyzing the measured acceleration and angular motion of the tire and determining the structural health of the tire. The controller may employ any of a number of machine learning processes and devices, including, but not limited to: a convolutional neural network, an artificial neural network, a Hopfield network, Baysesian networks, a Markov Chain Monte-Carlo method, for example, trained to determine whether the tire is experiencing tread separation (or other telltale signs) based on sensor measurements, such as acceleration, angular rotation, temperature, and pressure fluctuations associated with the tire, as determined over a period of time, for example. In example embodiments a library of classifiers may be developed and trained on data obtained from sensors that may be employed to identify specific types of failure (for example, specific types of delamination), as well as the degree to which the failure has progressed.

In example embodiments a monitoring system in accordance with principles of inventive concepts may be attached to a wheeled vehicle wheel-end, for example, and may monitor, analyze, diagnose, store, and report on conditions, such as potential delamination, related to a tire associated with the vehicle. Although illustrative embodiments are directed to wheel-end implementations, inventive concepts are not limited thereto. In example embodiments, sensors and/or processors need not be located on a vehicle wheel-end. That is, sensors may be located on a wheel-end (as described in greater detail in example embodiments), off of a wheel-end (on a vehicle cab or trailer, or within a tire carcass, for example), or a combination of both on- and off-wheel-end. Similarly, a processor may be located on a wheel-end, off a wheel-end, or both (in distributed processing embodiments). In embodiments in which a processor is located both on- and off-a wheel-end, the processor may be a distributed processor. In distributed processor embodiments, a relatively low-power processor may located on the wheel-end and a relatively powerful processor may be located elsewhere, such as on a vehicle cab or trailer, for example. As previously noted, sensors may include: accelerometers, pressure sensors, temperature sensors, video (visible, ultraviolet, or infrared, for example) sensors, or audio sensors, for example. In example embodiments, in order to reduce power requirements, a sensor (located, for example, on a wheel-end) may derive power from an electromagnetic query signal by inverting the signal in the manner of a passive RFID tag and may communicate with an off wheel-end processor through an RF link, for example. A sensor may transmit data directly to, or, in a distributed processing embodiment, through a wheel-end located processor, to an off wheel-end processor for data reduction and analysis.

In example embodiments a tire “health,” or roadworthiness, monitoring system may monitor, analyze, store, report or provide alerts for tire conditions, such as delamination or other tire conditions, that may reduce efficiency, impose hazards, or otherwise be of concern to a vehicle operator, owner or to the general public. An optical sensor (also referred to herein as a camera, which may be a still or video camera and which may operate in the visual, infrared, or ultraviolet range, for example) may be located off the wheel-end and may be powered by the vehicle voltage bus, for example. The optical sensor may be used to monitor a tire and, in conjunction with a processor and machine learning, may be trained to detect delamination in a tire and may relay images of the tire to a system, either on or off the vehicle, for further analysis and prediction, for example. Some types of tire failure may manifest themselves in the form of bulging or other abnormal tire profiles and these may be detected optically, in accordance with principles of inventive concepts. Optical systems may be mounted to view a tire's sidewalls in order to detect anomalies and to assess the tire-to-ground patch of a tire. In doing so, the vehicle hub weight, along with tire pressure, could be assessed. Hub weight may be employed to optimize tire pressure for a given load, thereby providing optimized fuel savings and tire wear. In example embodiments, a system and method in accordance with principles of inventive concepts may also assess the proper cargo positioning within a truck trailer in order to ensure proper balancing of cargo for safe vehicle handling and to determine whether cargo may have shifted during transit. If the system detects a load shift it may provide an alert, which may be one of a plurality of alert levels, depending upon the severity of the shift, thereby allowing a user or other party to re-secure the cargo. In this manner, damage to the cargo, to the carrying vehicle, or to other property, as well as potential injury to a driver or to the general public, may be avoided.

In example embodiments optical or sound sensors many be used separately or in conjunction with one another or with other sensors to monitor a tire for distress or impending failure, such as delamination, and may be mounted off wheel-end. The term “sound sensor” is used herein to refer to a sensor that detects pressure vibrations that may occur below, above, and including the audio frequency range. In example embodiments the sensors may periodically scan a tire and submit resulting information to a processor for analysis (including, for example, classifier comparison). A default period of scanning may be employed and, if a potential problem is detected initially, the period of scanning may be reduced, allowing the system to more closely monitor a potential failure until a determination regarding the likelihood of failure is made. Other off wheel-end sensors may include, for example, a brake slack adjuster position sensor that may be employed to determine the state of brake adjustment and may allow a system to provide alerts regarding brake performance and the need for replacement or repair. Suspension height sensors may be employed in accordance with principles of inventive concepts to provide data related to cargo load balance, proper tire pressure, and suspension component operation. For example, if the load is not properly balanced, the system may provide an alert and may, in embodiments that include automatic tire inflation, adjust the inflation pressure of vehicle tires to thereby adjust the load balance. Suspension height sensors may also allow a system to infer the weight of the cargo and also allow for proper inflation of tires. Suspension height sensors may also allow a system in accordance with principles of inventive concepts to monitor the “health” or roadworthiness of suspension components such as shock absorbers or springs, for example. Although a system in accordance with principles of inventive concepts need not be, in example embodiments described herein, at least a portion of the system is attached to a wheeled vehicle wheel-end. In example embodiments the system includes at least one controller but embodiments that employ a plurality of controllers are contemplated within the scope inventive concepts. In distributed embodiments, for example, one or more wheel-end systems (or subsystems) may include a controller that may collect, store, pre-process, format, or otherwise perform preliminary operations on data associated with a tire attached to a wheel end to which the wheel-end system is attached. The controller associated with the wheel-end may communicate data (raw or preprocessed) to a central controller on a vehicle associated with the wheel-end, or to a controller associated with a central dispatch or fleet control entity, where further processing, storage, and analysis may be carried out. The term “supervisory entity” may be employed herein to refer to an entity such as a maintenance, dispatch, fleet control or other entity that operates in conjunction with a driver to schedule, maintain, or operate a vehicle, for example.

In example embodiments a wheel-end unit may communicate directly with other wheel-end units associated with the same vehicle, may communicate with a vehicle-located controller, and from there, to other wheel-end units, to a driver, or to a central management entity, such as a dispatch or fleet control center, or may communicate directly with a driver, or a central management entity, for example. Communications may be direct, or through intermediary facilities and may employ wired or wireless, including WiFi, Bluetooth, cellular telephone, or the cloud-based communications, for example. In example embodiments each wheel-end unit includes a controller that may detect accelerometer data to determine from vibration signatures. Tire failures, such as impending delamination or bulges, for example, may be determined by comparing wheel-end signatures (based upon sensor data, such as vibration, temperature, and pressure) with example wheel-end signatures that either exhibit such imminent failures (e.g., known bad) or that do not exhibit such failures (known good). Such comparisons may also employ signatures from other wheel-end units associated with the same vehicle.

In example embodiments a system and method in accordance with principles of inventive concepts may employ one or more sensors to sense a characteristic of a vehicle tire. The sensing operation may take place when the tire is in motion, the motion related to an associated vehicle's travel, but for at least one type of sensing (for example, optical sensing) the tire need not be in motion. The sensing may be directed to: an acceleration of the tire, using an accelerometer; to sound emitted by the tire, using an acoustic sensor; or to electromagnetic emissions or reflections from the tire, using an optical sensor, such as an IR sensor, a visual band sensor, or a UV sensor, for example. Acceleration signals from an accelerometer may be used by a system and method in accordance with principles of inventive concepts to detect anomalous motion of a tire, or portion thereof, that may be indicative of a tire fault, such as delamination. Acoustic singles from an audio sensor may be used to detect anomalous noises that may be indicative of a tire fault. And electromagnetic signals may be used to detect anomalous heating profiles related to tread separation and associated friction (using IR sensing) or to detect a bulge in, or raised area of, a tire (using visual band sensing) for example. Sensors may be mounted in any of a variety of positions, including: a vehicle wheel-end, a vehicle cab, or a vehicle trailer, for example.

The system and method may monitor sensor signals to detect periodic variations that may be associated with tire faults and, in particular, with a fault that is localized on a portion of the tire. That is, for example, accelerations of a tire or portion thereof or sounds emitted by a tire may vary periodically as the tire rotates around an axle and makes periodic contact with a roadway. Such periodic signal variation, associated with the periodic rotation of a tire around an axle and its periodic contact with a roadway may be employed in a system and method in accordance with principles of inventive concepts to identify, analyze, and report on faults in a vehicle tire.

A system and method may employ machine learning to recognize a tire fault and to determine the severity of the fault. Machine learning may be used constantly or may be engaged after an initial indication of a fault (for example, a periodic signal anomaly) is detected. In example embodiments, sensor signals may be converted from the time domain to the frequency domain and the resulting frequency domain signals used to generate one or more spectrograms. The spectrograms may then be used to train classifiers and to generate a library of classifiers. After training, the library of classifiers may be employed by a system and method in accordance with principles of inventive concepts to classify spectrograms formed from signals generated by sensors “in the field” associated with traveling vehicles.

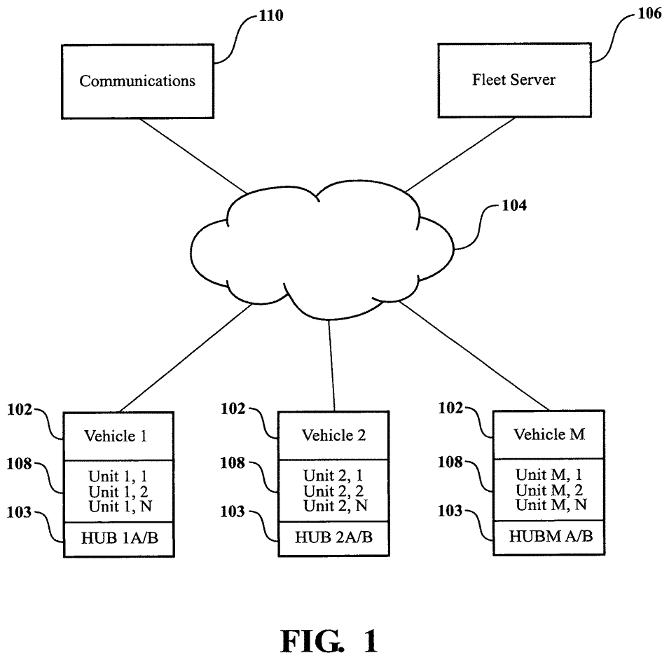

Turning now to the block diagram of FIG. 1, in some embodiments wheel-end units 108 may communicate directly with fleet server 106 through cloud 104 and may include an Internet interface, allowing fleet server 106 or portable communications device 110 to access raw data or analytics (e.g., diagnostics and prognostics) from each wheel-end unit 108, either directly or through hub 103 (which may be located on an associated vehicle, such as a trailer or cab, for example). Diagnostics and prognostics may employ, for example, a frequency domain analysis of nearest-neighbor tires (e.g., tires on the same end of an axle or those on opposing ends of the same axle) or of other “known good” or “known bad” tire signatures, for example. Such analyses may be used to determine whether wheels are out of alignment, whether a tire has been damaged, whether road hazards, such as pot-holes or road debris had been encountered, whether other impact events had occurred, whether foreign objects may have become lodged within a tire, or whether, in particular, tread delamination had begun, for example. Data may be employed, for example, to build or improve models for improved analytics. In example embodiments, tire wear and aging or deterioration of tires may also be detected through analysis. In some embodiments hub 103 may gather, organize and format raw data and analytic results from an associated vehicle for presentation to fleet server 106 or portable communications device 110.

The performance and capabilities of a wheel-end unit system 108 may extend beyond the confines of the monitoring, analysis and control system. Sensors 295, which may include optical, sound, or other sensor types, as previously mentioned, may exist external to the monitoring, analysis and control system and utilize the computing power of the monitoring, analysis and control system in assessing the status and health of the environment in the vicinity of the monitoring, analysis and control system and around the vehicle in total. For example, external sensors 295 may include brake system slack adjuster sensors. Such sensors may monitor the performance of a brake system slack adjuster and, as the brake system slack adjuster continually adjusts the brake system as the pads wear and moves into an area that may require vehicle maintenance, the monitoring, analysis and control wheel-end unit system 108 may communicate that knowledge to the appropriate personnel in an appropriate time frame to allow maintenance prior to field issues occurring. For example, a system in accordance with principles of inventive concepts may issue a warning to prevent tire delamination when delamination may be imminent (as indicated by sensor readings and analyses). Such a warning would be particularly beneficial while the vehicle is moving, as delamination can damage the vehicle with the delaminating tire and surrounding vehicles, as well. In example embodiments, a monitor, analysis and control system includes an air-compressor and air filter. By monitoring air filter performance, a system may determine the extent of air compressor wear. Additionally, in example embodiments, a system may monitor the temperature of a generator, or energy harvester, in accordance with principles of inventive concepts to analyze any aging issues that may expressed through temperature and, should aging become an issue, indicate that the generator should be replaced.

A system and method in accordance with principles of inventive concepts may be implemented using a vehicle monitoring, analysis and control system, such as described in greater detail in applications for which applicants claim priority, as noted above, for example. In example embodiments, a vehicle monitoring, analysis, and control system in accordance with principles of inventive concepts may include a wheel-end unit positioned on a wheel-end of a vehicle to generate electrical power, to provide high-frequency sensing and monitoring of wheel-end parameters, to analyze wheel-end health and functionality, to provide real-time control of wheel functions, such as tire inflation and load balancing. It may also provide communications, for example, among wheel-end units, to a central processor located on an associated vehicle, to a vehicle operator, or to a central vehicle control, maintenance, or dispatch facility, for example.

A vehicle monitoring, analysis, and control system in accordance with principles of inventive concepts may provide continuous, high-frequency sampling of wheel-end parameters provided by sensors such as a tire pressure sensor, a tire temperature sensor, accelerometer sensor, audio sensor, or moisture sensor, for example. In example embodiments, the steady availability of power enables continuous, high-frequency sampling of the various sensors, which, in turn, enables accurate monitoring, analysis and control of vehicle operations. Power may be derived, for example, from an inertial electrical power generator and/or electrical storage system within a wheel-end unit, for example, but other power sources are contemplated within the scope of inventive concepts. In example embodiments a system may employ a wheel-end unit including an energy storage system, such as a battery that may be charged, as described in greater detail herein, by interaction between a quasi-stationary element and a rotating wheel. Other charging methods are contemplated within the scope of inventive concepts, however. For example, solar charging, piezoelectric vibrational charging, wind energy (for example, with a pitot tube protruding from a wheel and using the wind to turn a rotor, electrostatic (for example, with a nylon brush rubbing against a rotating rubber wheel to generate a static charge), or sound generation (from road noise, for example) may be employed instead of or in supplement to a quasi-stationary system as described elsewhere herein. Applicants' system may perform latitudinal and longitudinal analyses of wheel-end functionality, providing diagnostics and prognostics for a wheel-end and for a vehicle associated therewith. The collected body of sensor readings allows the system to analyze wheel-end and vehicle performance in a manner far beyond the conventional detection of low tire-pressure. Applicants' system and method may perform extremely complex and accurate analyses in both the time and frequency domain.

Frequency analyses may employ Fourier, Gabor, or Wavelet transforms, for example, with machine learning to analyze the state of a vehicle, to diagnose issues, to prognosticate, or predict, potential long-term problems or imminent failures, recommend maintenance or control operations that improve vehicle performance, such as tire-delamination detection and early warning. In this manner a system and method in accordance with principles of inventive concepts may be directed to improving the overall safety, economy, and endurance of the wheeled vehicle.

Applicants' system may include a communications system that allows communications among wheel-end units, between wheel-end units and a vehicle central unit processor, between a wheel-end unit (or other notifying device) and an operator, and between a wheel-end unit and an off-vehicle monitoring, maintenance and control systems. In this manner, a system may provide constant, real-time diagnostics and prognostics to a vehicle central processor, in a driverless vehicle embodiment, for example, or to remote monitoring and maintenance systems, or to a vehicle operator, for example.

A sensor complement may include tire pressure, tire temperature, audio sensors, accelerometer, Hall Effect sensor, moisture sensors, optical sensors (for example, IR-, visual-, or UV-range cameras), and sound sensors, for example.

A wheel-end unit may communicate directly with other wheel-end units associated with the same vehicle, may communicate with other wheel-end units through an intervening hub, or may communicate with other wheel-end units through other communications channels, such as through the cloud. In example embodiments each wheel-end unit includes a controller that may detect accelerometer data to determine from vibration signatures whether the associated wheel is out-of-round by comparing the vibrational signature to the vibrational signature of wheels that are not out of round or by comparing the vibrational signature to the vibrational signature of wheels that are our of round. In example embodiments a wheel-end unit may compare measurements from axle to axle on the same vehicle to determine whether an associated axle is out of alignment (for example, if one wheel turns at a higher rate than another or) or brake dis-function (for example, brake drag or other failure) by comparing wheel rotation rates, temperature, and rate of change, for example. Tire failures, such as impending delamination or bulges, for example, may be determined by comparing wheel-end signatures (based upon sensor data, such as vibration, temperature, and pressure) with example wheel-end signatures that either exhibit such imminent failures (e.g., known bad) or do not exhibit such failures (known good). Such comparisons may also compare signatures from other wheel-end units associated with the same vehicle.

Returning to FIG. 1, an example embodiment of a vehicle monitor, analysis, and control system 100 in accordance with principles of inventive concepts is illustrated in the block diagram of FIG. 1. In this example embodiment M vehicles 102 each include N wheel-end unites 108. The trailer of a semi-trailer truck may include four wheel-end units, one for each dual-tire wheel-end, and the cab may include four, one for each wheel-end, for a total of eight wheel-end units 108 for each semi-trailer/cab combination. As previously noted, inventive concepts are not limited to wheel-end embodiments and may include, for example: brake slack adjuster position sensors that allow the system to determine the state of brake adjustment and resulting brake performance (and provide an alert regarding the advisability of repair or replacement);

suspension height sensors that allow the system to obtain information regarding cargo load balance (if the vehicle is not sufficiently level on a level surface the system may provide an alert for re-balancing); suspension height sensors may also allow the system to determine whether tires are properly inflated and may also allow the system to ensure that suspension components (shock absorbers, springs, for example) are operating properly.

As previously indicated, system 100 and wheel-end units 108 may be used in conjunction with any wheeled vehicle, whether off-road, commercial, industrial, or passenger. Descriptions herein will be directed to use with large trucks, but inventive concepts are not limited thereto.

Each wheel-end unit 108 includes a communications system including a transceiver that may provide communications using any of a variety of technologies and formats, including any wireless communications link such as Bluetooth, WiFi, RFID, infrared, visible or radio-frequency. Each wheel-end unit 108 may include a transceiver that allows the wheel-end unit to communicate with each of the other wheel-end units associated with the same vehicle it is associated with. Each vehicle (the term vehicle includes motorized vehicles, such as a semi-trailer cab and non-motorized vehicles, such as a semi-trailer trailer, for example) may include a hub 103 that may provide communications with all wheel-end units associated with the vehicle and may provide communications, through cloud 104, for example, with one or more fleet servers 106 or one or more portable communications devices 110, which may be a laptop computer, a pad computer, or a cellular telephone, for example. Hub 103 may provide vehicle control functions, such as for controlling an autonomous or remote-controlled vehicle, for example. Fleet server 106 may gather diagnostics and prognostic analysis results provided by one or more wheel-end units 108 and, at least in part, from those results may coordinate maintenance or replacement of vehicle systems or components. Each hub 103 may be associated with a trailer or cab and, in a semi-trailer truck embodiment, the combined vehicles (i.e., trailer and cab) may include two hubs 103, one each for the cab and trailer, or one hub 103 may service both the cab and trailer.

In some embodiments wheel-end units 108 may communicate directly with fleet server 106 through cloud 104 and may include an Internet interface, allowing fleet server 106 or portable communications device 110 to access raw data or analytics (e.g., diagnostics and prognostics) from each wheel-end unit 108, either directly or through hub 103. Diagnostics and prognostics may employ, for example, a frequency domain analysis of nearest-neighbor tires (e.g., tires on the same end of an axle or those on opposing ends of the same axle). Such analysis may be used to determine whether wheels are out of alignment, whether a tire has been damaged, whether road hazards, such as pot-holes or road debris had been encountered, whether other impact events had occurred, whether foreign objects may have become lodged within a tire, or whether tread delamination had begun, for example. Data may be employed, for example, to build or improve models for improved analytics. Tire wear and aging or deterioration of tires may also be detected through analysis in example embodiments. In some embodiments hub 103 may gather, organize and format raw data and analytic results from an associated vehicle for presentation to fleet server 106 or portable communications device 110.

A vehicle monitoring, analysis, and control system in accordance with principles of inventive concepts may be attached to a vehicle's wheel-end to monitor and adjust, for example, the air pressure of a tire associated with the wheel-end to which the system is attached. A plurality of such systems may be employed on a vehicle, with individual systems attached to each vehicle wheel-end.

As will be described in greater detail below, the electrical system may include a variety of sensors that are monitored by a controller (such as a microcontroller, for example). The controller obtains data from various sensors and processes the data. The processed data may be stored, analyzed and transmitted. The results of analyses may be used by the controller to control the pumping system in order to inflate an associated vehicle tire, for example or may generate recommended actions, that may be either immediate in nature or of a maintenance ongoing nature associated with the state of the wheel-end, axle system or trailer/tractor in total. This information may be transmitted to the driver or a third party using any of a variety of communications methods.

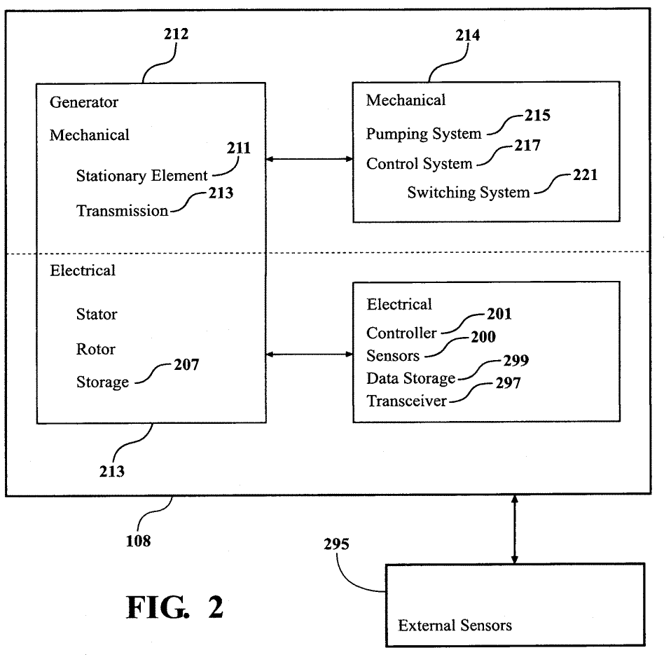

The conceptual block diagram of FIG. 2 provides an overview of an example embodiment of a vehicle monitoring and adjustment system wheel-end unit 108 in accordance with principles of inventive concepts. System wheel-end unit 108 includes a mechanical power generator 212, a mechanical system 214, and electrical power generator 213 an electrical system 216, all of which may be mounted to a vehicle's wheel-end.

Power generator 212 includes quasi-stationary element 211 (a weighted pendulum in example embodiments), which is supported along a central axis of the system on a system support shaft and is free to rotate thereabout. Although free to move about the axis of a shaft, quasi-stationary element 211 remains substantially stationary in its own reference frame, while rotating about the shaft in the reference frame of a substantial portion of the system wheel-end unit 108. Quasi-stationary element 211 may also be referred to herein as stationary element or pendulum, for example. Transmission 213 couples pendulum 211 to mechanical pumping system 215 and mechanical switching system 221, which, along with transmission 213, rotates along with the rotation of the vehicle's wheel.

With the transmission 213 and pumping system 215 rotating and pendulum 211 substantially stationary, the pendulum 211 applies a torque to the transmission 213, which transfers the torque to pumping system 215. The mass size and configuration, and the lever arm length of pendulum 211 are chosen to deliver sufficient torque for pump, and electrical generation actions through a wide range of a vehicle's operating speeds, without excessive travel of the pendulum. In example embodiments power generator 212 includes an electrical generator 213 and electrical storage 207 (also referred to herein, simply, as a “battery”), used to power electrical system 216. In example embodiments, electrical generator 213 is coaxial with a system support shaft, with the generator's stator 205 coupled to the system support (thereby rotating with the rotational portion of the system) and the generator's rotor 203 is coupled to the pendulum 211, thereby remaining substantially stationary; the relative rotation between the stator 205 and rotor 203 generates electricity.

Mechanical system 214 includes mechanical control 217 (including mechanical switching 221), pumping 215, and filtration 219, each of which will be described in greater detail below. Mechanical control system 217 engages transmission 213 with pendulum 211 within a range of operational parameter values and disengages transmission 213 from pendulum 211 outside that range. Pumping system 215 translates rotational movement provided by transmission 213 into linear movement used to operate pistons that compress air for use in maintaining proper tire pressure.

Electrical system 216 may include a controller 201, which may be embodied as microcontroller, or microprocessor and various support electronics, for example. Controller 201 may obtain data from a variety of sensors 200 and operate upon the data for a variety of analytical, control, storage, and transmission functions, as will be described in greater detail below. These sensors may include sensors internal to the monitoring, analysis and control system unit as well as those that may be external to the unit, sensors 295.

The availability of an electrical power generating source within the system affords the opportunity to perform many functions not available with a fixed electrical source that needs to conserve energy. Examples include the ability to sample sensors at much higher rates and for much longer durations than would typically be done in a battery-powered system. Additionally, the presence of a powerful processor, such as a microcontroller (MCU), System-On-Chip (SOC), FPGA, or ASIC, within the unit, allows the ability to perform intensive signal processing functions. As an example, sampling of accelerometer data at 16 KHZ can be performed continuously while performing Fast Fourier Transforms (FFT's) or Discrete Fourier Transforms (DFT's) via a 32-Bit MCU on the resulting signals, allowing the gathering of not only accelerometer magnitudes, which indicate things such as pot hole events, but also frequency information which are only available via much more power demanding operations that the aforementioned on-board processor can perform. In some embodiments, the system 108 may employ this data to perform analytics to provide diagnostics and prognostics heretofore unavailable.

For example, the system 108 may sample raw 10-bit or 12-bit data over long intervals (for example, at least one second recordings) at very fast rates (for example, at a minimum of 16 KHZ) to generate a sample file of the accelerometer recording of events that contain an array of precisely timed sensor readings. In this manner, system 108 may extract frequency domain data, rather than, or in addition to, just time domain data. By extracting frequency domain data, system 108 derives the data necessary for it to provide a significantly greater degree of signal processing capabilities, up to and including machine learning processes. With system 108 including a continuous internal power generating source 213, the system may sample numerous sensors, continuously and at a high rate. In example embodiments sampling resolution may most commonly fall within the 8-bit to 24-bit range, for example, with 12-bit resolution most common. Sampling frequency may be determined by a specific sensor's throughput capability, or update rate, but, generally, sampling is done at or above the Nyquist rate for a given sensed characteristic. For example, sampling frequency may be from 1 Hz for relatively slow-changing characteristics to the maximum capabilities of a system controller or sensor output capability. In example embodiments, a sampling rate of from 1 Hz to 16 kHz would be adequate to address many characteristics of interest, such as vibrational characteristics, which are typically manifested within a range of up to 8 kHz. Higher rates may be employed, for example, to sample vibrations within the audible range (for example, sampling at 40 kHz provides loss-free sampling for vibrations up to 20 kHz, the commonly accepted upper limit of the audible range). However, inventive concepts are not limited thereto.

The use of a main processor, controller 201, housed within wheel-end unit 108, allows sampling and analysis at high rates and to the fullest capabilities. Along with this, system 108 performs continuous monitoring and analysis of a variety of functions, components, and performances could generally be described as “wheel-end health.” Such operations may include, for example, monitoring wheel imbalance, which the system 108 detects via frequency domain readings of the accelerometer sensors; comparing the frequency domain results of one wheel, say wheel “A”, to the frequency results of a second wheel, say wheel “B.” Such a comparison, performed by system 108, allows system 108 to better discriminate between environmental effects, such as a bumpy road condition, that all tires may be experiencing, and single events that only one wheel may experience, such as damaging a tire from hitting a curb or pot hole. The processing capabilities of an always-powered system, recording at very high data rates, over long periods of time, and the ability of the wheel-ends to communicate with each other and share their data, allow the creation of a very powerful wheel-end health monitoring system with diagnostic and prognostic capabilities at each wheel-end, assessing performance for wheel-ends, extending to axle assemblies and units in total (e.g. axle alignment, etc.).

The performance and capabilities of a wheel-end unit system 108 may extend beyond the confines of the monitoring, analysis and control system. Sensors 295 may exist external to the monitoring, analysis and control system and utilize the computing power of the monitoring, analysis and control system in assessing the status and health of the environment in the vicinity of the monitoring, analysis and control system and around the vehicle in total. For example, external sensors 295 may include brake system slack adjuster sensors. Such sensors may monitor the performance of a brake system slack adjuster and, as the brake system slack adjuster continually adjusts the brake system as the pads wear and moves into an area that may require vehicle maintenance, the monitoring, analysis and control wheel-end unit system 108 may communicate that knowledge to the appropriate personnel in an appropriate time frame to allow maintenance prior to field issues occurring. For example, a system in accordance with principles of inventive concepts may issue a warning to prevent tire delamination when delamination may be imminent (as indicated by sensor readings and analyses). Such a warning would be particularly beneficial while the vehicle is moving, as delamination can damage the vehicle with the delaminating tire and surrounding vehicles, as well. As noted elsewhere, in example embodiments, a monitor, analysis and control system includes an air-compressor and air filter.

By monitoring air filter performance, a system may determine the extent of air compressor wear. Additionally, in example embodiments, a system may monitor the temperature of a generator, or energy harvester, in accordance with principles of inventive concepts to analyze any aging issues that may expressed through temperature and, should aging become an issue, indicate that the generator should be replaced.

An additional example embodiment of the use of external sensors 295 by system 108 may include suspension ride height sensors. These sensors may indicate the ride height of a trailer system and system 108, from the ride height, system 108 may calculate the weight and placement of load within the trailer. In some embodiments system 108 employs data collected from all of the wheel-end unit systems 108 associated with a trailer are analyzed by one or more of the systems 108 calculating the center of gravity within the trailer unit. Having determined the weight and displacement of load within a trailer, in some embodiments system 108 may optimize tire pressure, based upon load conditions (for example, higher pressures for heavier loads and vice versa). In some embodiments, system 108 may also assess and provide recommendations for load placement during the loading process or assess potential load shifts during transit. If system 108 determines that a load has shifted, it may alert a driver or manager, either through an optional local user interface (for example, a display and voice, keyboard, keypad, or soft keypad input) or through the cloud 104 to fleet server 106 or portable communications 110 link previously described. Analysis and control using additional types of external sensors, including pressure, temperature, moisture, sound, light level, air filter performance, etc., are contemplated within the scope of inventive concepts.

Data storage 299 may be used to store raw or processed data, analytical results, or data or commands received from other controllers associated with a vehicle or from a separate, possibly centralized, data source, such as a vehicle data center or fleet server 106. Electronic communications may be implemented through transceiver 297 and may allow a system in accordance with principles of inventive concepts to share data and analyses among a plurality of systems or other electronic devices, including a vehicle operator's electronic system, a vehicle dispatcher, or a maintenance manager, for example.

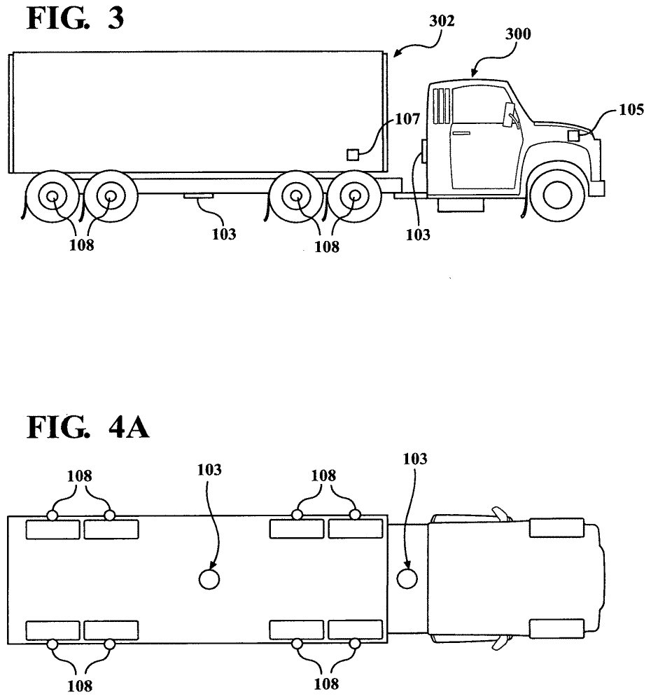

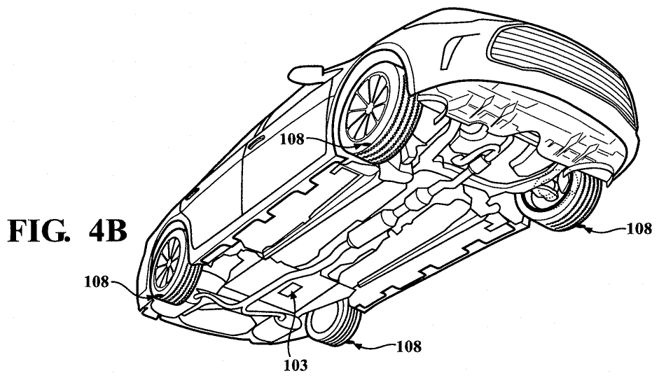

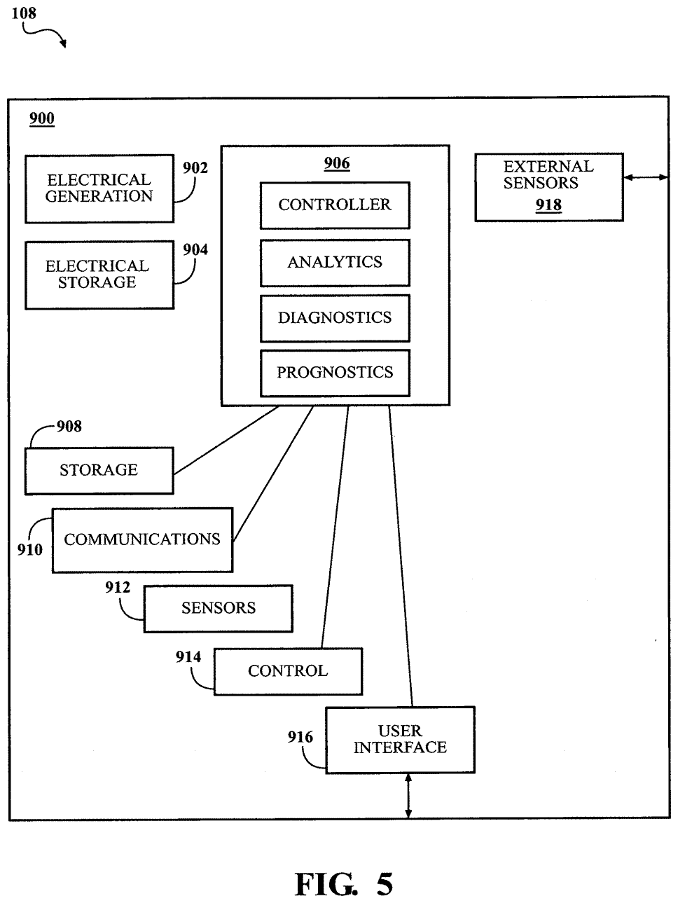

FIG. 3, illustrates, in side view, a plurality of vehicle wheel-end systems 108 in accordance with principles of inventive concepts configured on a vehicle 300. In this example embodiment, the systems 108 are mounted on motored vehicles 300 or trailered units 302 (a tractor 300 and semi-trailer 302 in this example embodiment). The wheel-end systems 108 are shown installed on all powered and trailered (non-powered) wheel assemblies, though a combination of installed and not installed on some wheel assemblies is contemplated within the scope of inventive concepts (for example, installed on powered axles only, or installed on trailered (non-powered) axles only, or installed on a combination of both trailered (non-powered) and powered wheels or as depicted in the illustration). The systems 108 are installed on wheel-ends and provide a distributed set of vehicle monitoring, analysis, and control systems that, among other things, provide tire pressure monitoring and automatic tire inflation. Sensors may be located anywhere on a vehicle that provides sensing opportunities for a given sensor, such as in wheel-end systems 108, or in units 105 or 107 on cabs (also referred to herein as tractor) 300 or trailers 302 respectively, or similar location on a unitary vehicle, such as that of FIG. 4B, for example.

In example embodiments, each system 108 may operate autonomously to monitor and adjust vehicle attributes, such as tire pressure, associated with the wheel-end to which they are attached. Additionally, each system 108 may store, process, analyze and transmit or receive information (that is, raw data, analytical results or commands, for example) associated with the wheel-end to which they are attached. Such information may be shared with a central processor, or hub, 103 connected to, or associated with, a vehicle (located in either tractor 300 or trailer 302, for example) or one of the systems 108 may operate as a central processor or hub. Each wheel-end system 108 may provide vehicle monitoring, analysis, and control, including, for example, tire pressure monitoring and pressure adjustment for both single and multiple tire combinations as might be configured on a given wheel-end.

Hub 103 may forward sensed, calculated, or analyzed information generated and/or obtained at the monitoring, analysis and control systems 108 to vehicle operators or logistics/maintenance providers as is instructed or designated by the communications controller 103, and as previously described.

FIG. 4a is a plan view, schematic representation displaying monitoring, analysis and control system systems 108 on both motored 300 and trailered (non-powered) 302 vehicles. (FIG. 4b depicting a similar passenger vehicle representation). A hub unit (103) may be positioned on the motored vehicle 300 or on the trailered vehicle 302. The transmitter/receiver unit (103) may communicate between the individual or collective wheel-end, or, monitoring, analysis and control, systems 108 with the world external to systems 108, for example, as determined by preset protocols defined during the set-up of the system. Programmable system parameters may include, but are not limited to: alert notifications, including the type of item to alert, what person/entity to notify; system parameter settings, including tire pressure setting, security setting (e.g. password, type of unauthorized removal actions, etc.); and systems to activate, including system performance monitoring, diagnostic systems, prognostic systems, for example. In example embodiments, the programing/set-up of the monitoring, analysis and control system systems 108 may be performed via a base unit or, for example, via an application as installed on a portable device 110 such as a smart phone.

In example embodiments, sufficient power is supplied (for example, through a power generator assembly such as described in related applications) to operate a controller, or main processor (for example, a microcontroller (MCU), a System-on-Chip (SoC), a Field Programmable Gate Array device (FPGA), or a custom Application-Specific Integrated Circuit (ASIC)). Additionally, resistive circuitry elements (such as, but not limited to, Resistors, or resistive traces on circuit boards) may be employed to convert available current flow into heat, resulting in warming of critical parts of a system to prevent freezing or adverse operating conditions. Additionally, such circuit elements could possibly be used to provide a means of removing excess or unwanted moisture in a system by elevating system or area temperature. This heating may be selective and targeted to a specific area, or may be generalized to a system to maintain a desired overall temperature profile range, for example.

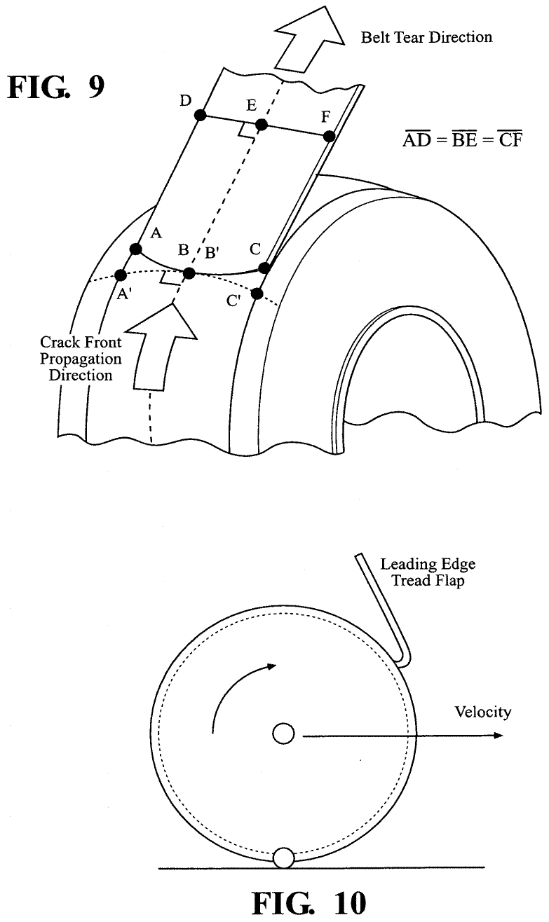

The functional block diagram of FIG. 9 provides a more detailed view of an example embodiment of a wheel-end system 108 in accordance with principles of inventive concepts. System 108 includes an electrical power system 900, controller 906, electronic storage 908, a communications system 910, sensors 912, control electronics 914, a user interface 916, and an external sensor interface 918.

Electrical power system 900 includes electrical power generator 902 (which may be the same as 212 described in relation to FIG. 2) and electrical power storage system 904 (which may be the same as 207 described in relation to FIG. 2). In example embodiments electrical power system 900 operates in conjunction with a mechanical power generator, which is described herein and in a patent application entitled, “APPARATUS AND METHOD FOR VEHICLE WHEEL-END GENERATOR,” having the same inventors and filed on the same day as this application, and which is incorporated by reference in its entirety.

Electronic storage 908 may include volatile or non-volatile electronic memory, such as ROM, EEPROM, Flash, DRAM, phase-change, or other memory. Electronic storage 908 may store sensor readings; controller calculations, analyses, diagnostics, and prognostics; information obtained through user interface 916 (commands, updates, etc.); information obtained through communications interface 910, such as sensor readings, analytics results, diagnostics and prognostics from one or more other systems 108 associated with the same vehicle as the instant system 108; or information or commands from remote devices, such as fleet server 106 or portable communications device 110, for example, through cloud 104.

Communications interface 910 may employ any of a variety of formats and technologies to provide communications among systems 108 associated with a particular vehicle or, directly or through cloud 104, with portable devices 110 or fleet server 106, for example.

Sensors 912 provide readings on tire pressure, tire temperature, motion (e.g., three dimensional accelerometer), wheel temperature, ambient pressure, ambient temperature, wheel temperature, microphone, distance sensors, color sensors, humidity sensors, altimeters, Hall effect sensors, air flow (e.g., Pitot tube), camera (IR, visible, low-light level, etc.), for example Sensor readings may be employed by controller 906 in analytics, diagnostics and prognostics, as described in greater detail herein.

Control electronics may include electromechanical devices, such as solenoids or solenoid valves, employed by controller 906 to control gas flow into or out of tires to thereby ensure proper tire inflation for load-leveling, for proper tire wear, for fuel efficiency, and for safe vehicle operation, for example. A piston control, for operation of one or more pumps, or control for engagement of a clutch or other mechanism to engage or disengage an energy harvesting, or generator, element, such as a inertial mass or quasi-stationary device described herein.

User interface 916 allows a user, such as a vehicle operator, to securely query, adjust, or command a system 108. Input and output through the user interface 916 may employ audio, touchpad, keyboard, stylus, via a standard interface (e.g., USB port), and display, for example.

Controller 906 may be implemented, at least in part, using a microprocessor, microcontroller, application specific processor, system on a chip, or digital signal processor, for example. Controller 906, in addition to controlling the sampling of sensors 917, performs analyses, diagnostics, and prognostics, as described in greater detail herein.

External sensor interface 918 provides communications with sensors that may be external to system 108 such as a camera, for example.

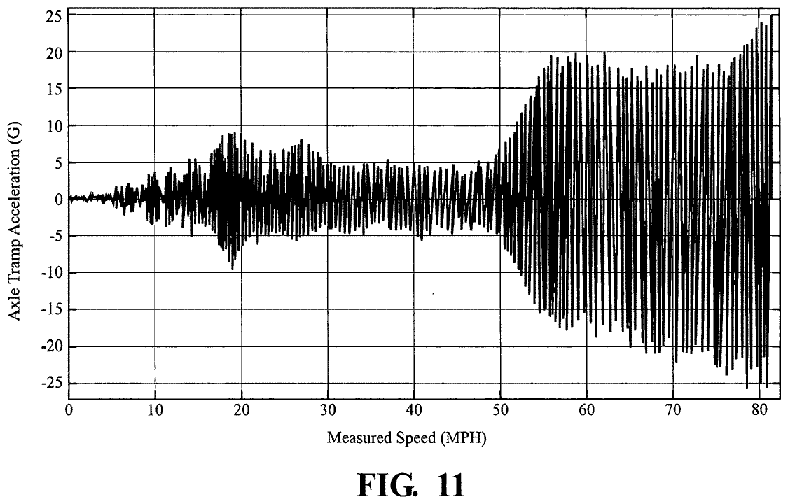

The detailed block diagram of FIG. 10 illustrates a combination of electronics, electromechanical, and mechanical components of system 108, with interfaces to tires (Tire A and Tire B) of a dual-wheel example embodiment. In example embodiments, Statis mounted sensors include slack adjuster inputs and image sensors and BLE refers to a Bluetooth Low Energy transmitter/receiver. In this example embodiment a micro SD card may be used for extended storage during prototyping and a flash card used during production for storing “black box” information, such as impacts (e.g., pothole strikes) and tire removals, for example. Controller 906 employs valve control circuits 1-6 to control a piston (valve 6) to start a pump that employs the previously described mechanical power generator to fill reservoirs 1 and 2, which supply air to tire A and tire B respectively. Controller 906 employs valve 1 to control the supply of air to reservoirs 1 and 2, valve 2 to vent reservoirs to atmosphere, valve 3 to supply or vent air to tire A, valve 5 to supply or vent air to tire B, valve 4 to equalize pressure between reservoirs 1 and 2. A three axis accelerometer is employed to determine various accelerations, as described in greater detail herein, a Hall effect sensor is employed to determine the rotation rate and total rotations of an associated wheel-end, total mileage and so on as described in greater detail herein. Signal conditioning circuits filter and amplify signals, including those from tire temperature sensors 1 and 2 and tire pressure sensors 1 and 2.

In accordance with principles of inventive concepts, system 108 may be controlled using electrical/electronic control systems. Such systems may rely on direct or indirect sensor inputs. The control system may integrate assembled raw data input collected over various time frames or create representations of situations resulting from either predetermined predicted events or as developed as a result of analysis or synthesis of data amassed for trend analysis, for example. In example embodiments this enables the diagnosis of the system's current state or the determination or prediction of future states of the system. In example embodiments such predictive assessments are in the form of transient or steady state predictions. These predictive performance processes and data based unit-specific operational projections allow system 108 to determine or execute actions that may result in the overall tire inflation system being maintained in optimal performing condition or provide an accurate forecast of near term operational performance of the tire(s) associated with system 108. In example embodiments, system 108 may communicate the actions performed or the predictive information to a vehicle operator through user interface 916 or communications interface 910 or a vehicle maintenance/logistics manager at fleet server 106 or portable communications device 110, for example.

Controller 906 may include a number of sensor inputs, including any of those identified herein. Inputs to the main controller 906 (for example, Microcontroller (MCU), System-on-Chip (SoC), Field Programmable Gate Array device (FPGA), or a custom Application-Specific Integrated Circuit (ASIC), etc.), which may be used to calculate Diagnostics and Prognostics for the operational performance or forecast communication of the inflation system, may include those indicated as the functionality of a system in accordance with principles of inventive concepts is further disclosed.

In example embodiments controller 906 may actively and continuously monitor (e.g., many times, per second) all sensors when an associated vehicle or system 108 is in motion, and, upon request, when system 108 is not in motion though, perhaps, at lower frequency rates. Power for the system may be from a power generator 900 (also described as 212), which may provide continual power to system 108 whenever the vehicle is in motion. This continual availability of power may allow sustained sampling protocols for sensors and other inputs at a rate much greater than is possible with fixed energy (e.g. non-rechargeable battery) source devices. These higher sampling rates not only provide a greater level of real-time knowledge of what is transpiring within a vehicle system, but may also allow for much greater capabilities as to signal analysis. In example embodiments, such analyses may include Frequency Analysis and Spectral Analysis (such as, but not limited to Fourier Transforms, Gabor Transforms, Power Spectral Density Analysis, etc.) for the sensor data.

The performance of frequency analysis on various sensors within the system in accordance with principles of inventive concepts provides many benefits. For example, by using Fast Fourier Transforms (FFT's), system 108 may detect frequency abnormalities via one or more accelerometers to provide early warning to a driver (or other) of issues with a tire, for example. Through use of Gabor Transforms, a system in accordance with principles of inventive concepts may develop predictive behavior, thereby enabling the use of Artificial Intelligence in example embodiments. These types of analysis may be possible due to the frequency and volume of sensor data collected, for example, into the Megahertz range and over sustained periods of time (in the range of seconds or greater in example embodiments). Such sampling is made possible as a result of power availability, as generated within system 108. The availability of such a continual power source also allows system 108 to transmit data, analytic, diagnostic, and prognostic results over wireless circuitry at full power without the need for power conservation in example embodiments.

In example embodiments, tire air pressure may be monitored over time (1 sensor per tire, or multiple tires per sensor). Additionally, redundant pressure sensing may be employed. In example embodiments redundant pressure sensing methods may include: direct sensing, which may include primary pressure sensor (s) (Digital or Analog), or indirect sensing, which may include wheel speed & temperature monitoring or other methods. Indirect methods may be utilized as stand-alone monitoring methods or as a means of assessing/confirming performance of direct sensing elements. In addition to pressure monitoring, temperature monitoring may also be provided real time or over time to provide an accurate assessment of the pressure/temperature state of the tire or an inflation reservoir in example embodiments. To that end, example embodiments may use direct sensing using a thermistor or thermocouple, with either providing an analog type of output, or possibly, a temperature sensor providing digital output. The collecting of both the state of pressure associated with a given temperature in example embodiments provides a more complete assessment of the state of a tire or reservoir pressure and determination of actions if any necessary to achieve a desired state.

System 108 may monitor wheel RPM over time to yield diagnostic and prognostic results. In example embodiments, collecting data to assess both speed and distance traveled may be performed both directly and indirectly. In an example embodiment a system includes direct sensing of the rotation of the monitoring, analysis and control system 108 primary shaft axis A through the use of Hall Effect sensors or similar methods, providing both number of rotations as well as an associated time per rotation. In example embodiments, power generator signal phases may be used as a redundant or backup check on actual direct sensors, or may be used in lieu of direct sensors. For example, Hall effect Sensors may be a primary or a direct method of monitoring wheel rotation, to both calculate the wheel rotation speed and for odometer functionality. Use of built in Analog to Digital capabilities of controller 906 to monitor the phase of the electrical generator, allows monitoring of wheel rotations indirectly, for example, by tracking the different phases of the generator The capturing of this information provides both a means of checking Hall Effect sensor performance, with a second method of monitoring wheel rotation and an alternative way to monitor wheel speed, by measuring the frequency of the signal. In example embodiments this provides the ability to closely monitor critical sensor functionality for Tachometer and Odometer functions, as well as, general motion of system 108, with both direct and indirect monitoring methods.

Using wheel rotation monitoring in example embodiments may provide a means of determining miles traveled by system 108 or an associated wheel/tire assembly (for example, by multiplying the number of rotations by the outside circumference of an associated tire). In example embodiments this information may be used internal to assess the current status of the system and to forecast future system status. Additionally, in example embodiments such information may be used to advise the vehicle operator of upcoming periodic mileage-based events, such as filter replacement, tire replacement, or simply providing an axle mileage indicator, which an operator may employ to determine whether to replace an axle or other component, for example.

In example embodiments, the controller may monitor multiple sensors, both direct and indirect, to determine performance status, using tiebreaker logic (both real time, and over time), as well as, nearest neighbor data assessment to determine which sensors are performing adequately and which sensors the system should most trust. In example embodiments this logic may apply to tachometer and odometer functions, as well as other system parameters/sensors within system 108.

Example embodiments of system 108 monitor vibrational inputs to the system through the use of 3-axis accelerometer sensors. These vibrations may come from many sources and their analysis allows system 108 to provide added insight into the overall health of the wheel-end to which system 108 is attached. For example, accelerometer inputs, including both frequency and magnitude, may be analyzed for periodic perturbations of the rotating system, and compared to known issue states. Such data, and associated analysis by system 108, may provide early notification capabilities for such things as tire anomalies such as tread wear, incorrect size tire, tire bulges, tire deformations, foreign objects (e.g., nails, screws or other sharp objects), or other damage, for example, developing wheel-end issues, such as worn bearings, wheel-end and road-induced wheel damage such as locked brakes, damage rims, etc., for example. Additionally, in example embodiments, identifying pot-hole strikes and damage associated with the strike may be provided by a system in accordance with principles of inventive concepts. Time stamps by controller 906 of such an event, along with GPS location data for that time stamp (in example embodiments a GPS receiver is included in system 108 or GPS data may be obtained through communication with a separate system on board the vehicle), may provide documentation for the location of damaging road conditions, providing early identification of deteriorating road conditions, facilitating their rapid repair, or possibly providing documentation of vehicle damage.

In example embodiments, battery voltage status may also be monitored using, for example, direct sensing resistor divider input, providing replacement recommendations when levels fall below a prescribed level. Notifications may be made to the vehicle operator or the logistics manager, possibly multiple times; initially as voltage levels fall to a low, but functional level, and subsequently as levels fall to nonfunctional levels. Where such information may not be available, users may be instructed to replace batteries on prescribed time-based intervals, independent of battery status. Additionally, smart battery conditioning and monitoring processes may be employed by a system in accordance with principles of inventive concepts.

Similarly, a system 108 filter assembly may be monitored by the controller for filtering performance, indirectly, for example, by monitoring pumping efficiency, or other sensor or filter performance related data. Should such monitored values reach a targeted level, notification may be sent, for example, to the vehicle operator or a logistics manager (through fleet server 106 or portable communications device 110, for example). There may be multiple levels of notification with regard to filter performance, similar to battery replacement, indicating varying levels of filter contamination. Filter assembly replacement, in the absence of this predictive method of filter assessment, may be done through instructions to a maintenance provider to do periodic time-interval based replacement. A filter assembly may additionally be monitored for actual removal from the vehicle through direct methods, such as use of magnetic switching or make-break contact switching, which could detect the removal of the filter assembly from the lower housing of system 105, or possibly indirect sensing based on “burp” rate differences between the new and old filter with the older filter having slower “burp” rates. The monitoring of filter replacement allows the monitoring of number of miles of active pumping, as well as, total miles, which could be used in determining filter replacement requirements.

In example embodiments, other parameters and functions may also be monitored by system 108. The monitoring of such parameters/systems may provide confirmation of proper ongoing performance or may provide indicators of near term performance issues that may warrant attention or possibly security concerns. Examples of such areas that may be monitored in accordance with principles of inventive concepts include: generator assembly (electrical or mechanical) parameters such as voltage over time, or voltage phase lag possibly using resistor divider input; generator assembly temperature over time, possibly using thermistor, thermocouple or digitals temperature sensors may also be monitored or collected; regulated voltage outputs, including 12V DC Buck/Boost Switching Regulator, associated with elements of the system such as valves, etc., and possibly 3.3V DC Buck Switching or LDO Regulator as may relate to electronic circuitry or the like. Control circuit current consumption may also be monitored, possibly with a Low Ohmic Shunt Resistor or similar means as well as possibly magnetic trigger pairing sensor status for security purposes, and wireless signal strength via Relative Received Signal Strength (RSSI) feature possibly on a Transmitter/Receiver.

In example embodiments, the monitoring of these parameters may provide an indication of many factors, including: vehicle running time, miles traveled, energy harvester and associated bearing health, as well as providing the basis for performance actions such as operational health of the electrical generator, operational health of electrical valves, energy harvester perturbation control, generator oscillations, time and speed based notifications and calculations, authorized or unauthorized removal of the monitoring, analysis and control system 108 from the vehicle, external communications status, etc.

In example embodiments controller 906 may also rely on a Real Time Clock (RTC) or a timer within a microcontroller to help monitor time for functions that may include both diagnostic and prognostic functions, examples of which are described below. In addition to system time, many short-term events may be closely monitored, such as vibrations per second, etc., and, thus, the internal resources of the controller, such as high-speed timers based on the main oscillator will be frequently used for such purposes, allowing for very accurate short timescale, for example, down to the microsecond range.

In example embodiments, controller 906 may actively and continuously monitor the state of the entire system 108. When the vehicle/system pair is in motion, these element states may include, but are not limited to: state of flow related valve assemblies, state of compressor pump assembly, state of the energy harvesting transmission mechanism, state of filter assembly performance, state of battery assembly, pairing state, with/and between systems 108, nearest monitoring, analysis and control system neighbor(s) state. The controller may also monitor the pairing state of a magnetic pairing sensor. The pairing sensor state change related to the position of lower cover magnet and wheel mounting bracket magnet. The removal of a system 108 from the vehicle may cause a state change in the magnetic pairing sensor. In example embodiments, protocols may be included in the controller that may identify authorized state changes versus those that, in the absence of aforementioned protocols, may be deemed as unauthorized state changes. The protocols may include specified wireless signals to the controller or other removal authorization methods. An unauthorized removal may result in system shut-down, a notification sent to designated entities, etc. Valve assembly, compressor pump, reservoirs, energy harvesting transmission mechanism, and filter assembly are described in greater detail in applications having the same inventors as the instant application, including one entitled, “APPARATUS AND MENTHOD FOR VEHICLE WHEEL-END FLUID PUMPING,” filed on the same date herewith, which are incorporated by reference in their entirety.

In accordance with principles of inventive concepts, system 108 may be controlled using electrical/electronic control systems. Such systems may rely on both direct and/or indirect sensor inputs. The control system may integrate assembled raw data input collected over various time frames and/or create representations of situations resulting from either predetermined predicted events and/or as developed as a result of analysis and/or synthesis of data amassed. In example embodiments this enables the diagnosis of the system's current state and/or the determination and/or prediction of future states of the system. In example embodiments such predictive assessments are in the form of transient and/or steady state predictions. These predictive performance processes and data based unit-specific operational projections allow system 108 to determine and/or execute actions that may result in the overall tire inflation system being maintained in optimal performing condition and/or providing an accurate forecast of near term operational performance of the tire(s) within the system. In example embodiments, this control system is capable of communicating both the actions performed and/or the predictive information to a vehicle driver and/or the vehicle maintenance/logistics manager at fleet server 106 or portable communications device 110, for example.

In addition to system performance monitoring, in example embodiments the controller 906 may also perform diagnostics. One such diagnostic is the use of a non-contact thermal monitoring method, using, for example, infrared thermal sensors. These thermal monitors may provide an indicator of potential issues within systems being monitored, for example, related to elevated temperatures, or analysis of elevated temperatures and frequency of elevation, or the rise rate in temperatures of a system/component, etc. Thermal sensor monitoring may be performed on components/systems within the confines of system 108 or external to system 108. System 108 monitoring, for example, the electrical generator 902 or support bearings may provide early warning indicators of binding conditions and or other high friction situations. Frequent heating of the pumping system may, reveal, for example, issues with valving within the pump cylinder head or elsewhere.

Temperature sensor monitoring from system 108 may also be employed on locations external to system 108. Directing thermal sensors on preselected positions on the wheel or wheel hub, may provide information relating to wheel bearing status (e.g. binding from improperly adjusted wheel bearings, deteriorating bearing elements, etc.), brake status (e.g. brake drag from improperly functioning brake adjusters, corroded elements, etc.), etc. A system and method in accordance with principles in accordance with principles of inventive concepts may thereby provide an indicator of properly performing systems, and identify deteriorating systems when issues are in their infancy, before major issue develop.

Additional systems that may be monitored in example embodiments of system 108 using a variety of sensing for diagnostics may include an evaluation of the following: Sensor Performance—in example embodiments the controller compares a first sensor's values to a second sensor's values immediately after corresponding reservoirs have been equalized. If differences are greater than acceptable threshold, comparison of other values on the sensor modules in system 108 may be executed to identify an errant sensor. Additionally, a backup pressure sensor verification assessment may be performed by assessing system rotations and wheel speed. A given tire pressure may result in a rotational speed for a given diameter at a designated vehicle speed. Comparing sensors values to same axle “neighbors” may provide axle speed and tie-breaking methodology may identify the errant sensor. Repeating the process of setting tire set-points at adjusted pressures may be employed to assess whether the errant sensor has a calibration issue or has a read capability issue. The calibration issue may be correctable based on a possible calibration adjustment based on “neighbor” sensor values methodology. Temperature sensor performance may be assessed in a similar manner coincidently with the assessment of the pressure sensor. Monitoring performance over time may allow an assessment of the health and performance of both the pressure and temperature sensors and a history of any past divergences.

In example embodiments of a system 108 in accordance with principles of inventive concepts controller 906 may perform a number of operations to assess the functional health of the electrical generator assembly 902. Such operations may include, for example, controller 906 comparing temperature and current to nonvolatile flash memory threshold value; saving RPM, current and temperature readings to nonvolatile memory and reporting any threshold variances; monitoring voltage phase lag; initiating generator braking circuitry (for example, applying a large load by shorting two legs of the generator output together for a short time) to counteract oscillation and to re-stabilize the pendulum, in response to oscillation determined by controller's analysis; monitoring generator performance under various states (such as before and during pumping, before, during and after Valve actuation, etc.) to determine an electrical fingerprint (current, voltage and phase lag of generator) during the pumping. System 108 monitors this electrical fingerprint will over time to help complete the health check of the generator and to monitor potential problems with the pendulum and other generator components.

Controller 906 may monitor valve performance, for example, by manually pressurizing a reservoir and measuring and monitoring a pressure leak rate for each reservoir and comparing the leak rate to a threshold value (stored, for example, in nonvolatile memory). Controller 906 may save the leak rate and report any threshold variances. Controller 906 may monitor generator performance before and during valve actuation to determine an electrical fingerprint (current, voltage and phase lag of generator) during the actuation. This electrical fingerprint is monitored over time to help complete the health check of the valves and their control circuitry. For example, an increasing leak rate may indicate deterioration of valves, hose, or other fluid system components.

Controller 906 may monitor compressor and piston performance by self-testing by pressurizing a reservoir for this operation as needed (for example, on a regularly scheduled maintenance basis) comparing pressure rise rate to a threshold value, saving the rise rate readings and reporting any threshold variances. Controller 906 may monitor Generator performance before and during pumping to determine an electrical fingerprint (current, voltage and phase lag of generator) during the pumping. This electrical fingerprint will be monitored over time to help complete the health check of the compressor pump (and piston performance). For example, in original condition the pump may require a given number of cycles (e.g., 200) to increase pressure by one PSI, but, over time, the compressor pump may require more cycles (e.g., 250) to increase pressure by the same amount. Monitoring these values over time and analyzing the changes and rate of change may be used in accordance with principles of inventive concepts to predict failure or advise maintenance, for example.

In addition to diagnostics, a system in accordance with principles of inventive concepts may collect current state information and, based on analysis of that data, with a prior knowledge of system state performance or other information, may forecast future system performance events or, through real time actions, avoid negative outcomes.

Such forecasts may include an assessment of leak rate, as well as an identification of low pressure. This may include an identification of a low-pressure state and a determination of pumping system “ON” or pumping time requiring the identified low-pressure tire to attain proper, or targeted pressure level. It may also include a monitoring of time between re-inflation events and the time that the pumping system may be in an “ON” or pumping state. To that end, each low-pressure event may be tracked in a Fill Tire Protocol functions, where information tracked may include parameters such as, mileage, date, time, fill time, etc. A comparison may be made to nearest neighbor (for example, a second tire on the same wheel-end or a second tire on the opposing end of an axle, or a second tire on the nearest neighboring wheel-end) performance, as well as, an expected performance data set. A calculation of the tire pressure loss rate may be done, with collected data, for example, including the aforementioned data or including: fills per given distance (100 miles, for example); or fills per given time span (one day, for example) if there may be periods of vehicle idle time in the assessed period; fill period or active duty time of the pumping system, temperature rise rate per given distance (for example, per mile), temperature rise rate for a given time period (for example, per minute), comparison of temperature change to “nearest neighbors”, etc. The use of the data identified and the knowledge of pumping system performance capability may be employed in accordance with principles of inventive concepts to project system's 108 ability/capability to maintain system target pressures, or the duration that target pressures may be maintained. This information may be communicated to the vehicle operator or a logistics manager, allowing a proper assessment of type of maintenance actions that may be desired/taken or scheduled based on such forecasts.

Monitoring of the electrical generator assembly generated electrical signature and comparison to expected performance bands. This comparison may identify initiation of potential/possible abnormalities. Such abnormalities may include, among other observances, oscillations of the energy-harvesting mass 723, based on indicators such as phase perturbations within the electrical signal. These oscillations, if unheeded, could result in fluctuations in power transmission performance or could require adjustment of the inertial mass of the energy harvesting system. Adjustments to minimize such oscillations may be employed, based on managing or manipulating electrical and mechanical induced force or load demands placed on the energy harvesting system, as well as, through the selectively short circuiting of two (or more) legs of the power generator assembly (e.g. stepper motor) causing a braking type force to occur, as previously described.

General vehicle health and predictive assessments of same may also be provided in example embodiments, through the collection or assessment of operating parameters developed by the various monitoring, analysis and control system units on a given vehicle. The information collected may be used in total or in various combinations such as, across vehicle on “shared” axles, or “like side neighbors” or tractor to trailer, as well as other combinations. Parameters that may be collected for such combining and parsing may include, but are not limited to; wheel rotational speed; wheel accelerations/vibrations across multiple axis; temperatures, both transient and steady state; etc. The collecting and combining of information in combination with a review of preferred performance and difference between or amongst may allow identification for instance of brake drag due to improper slack adjuster or other similar induced brake retraction issues. This may initially be seen with a comparison of wheel rotational numbers, globally on the vehicle initially and with refinement cross axle, potentially followed, if not resolved, by temperature differences between hubs. Number of wheel rotation analysis may also reveal axle misalignments. An axle-to-axle analysis may indicate that one axle is not aligned perpendicular to the vehicle's travel direction and, thus, scrubbing and causing excessive tire wear. Vibrational analysis of accelerometer data, may be employed to identify out-of-round wheels, or dented wheels, or impending delamination. Each would be assessed based on differing combinations of accelerometer data combinations and the signature of the accelerometer data captured.

In operation, a system 108 may employ a classifier to analyze sensor readings, use sensor readings to diagnose system 108 and associated vehicle states or prognosticate future system 108 or associated vehicle states, for example, in regard to maintenance or possible faults or failures. Readings from any sensor may be used, singly, or in combination with readings from other sensors. In the following example, readings from an accelerometer will be used for illustrative purposes, but inventive concepts are not limited thereto.

In operation, a sensor, which may be a three-axis accelerometer, for example, detects vibrations, converts the mechanical vibrations to an analog electrical signal, conditions the signal (using, for example, an electrical filter and multi-stage gain amplifier) converts the analog electrical signal to a digital signal and passes the digital signal to controller 906. Various of these operations may take place in either the sensor or processor 906. In exemplary embodiments in accordance with principles of inventive concepts, data may be pre-processed, for example, by performing normalization, feature scaling, and regularization to enhance the accuracy of a sensor system in accordance with principles of inventive concepts.

As will be described in greater detail below, in exemplary embodiments processor 906 converts the time domain signal (time vs amplitude) received from the sensor to the frequency domain (frequency vs amplitude), then transforms the frequency domain signal to a spectrogram image (frequency vs time). In exemplary embodiments in accordance with principles of inventive concepts, a time/amplitude representation may be converted directly to a time/frequency representation. Wavelet transforms may be employed to perform such a transformation, for example. During regular operation, this image is then employed by a trained classifier, described in greater detail below, which may be implemented on controller 906, for example, to identify characteristic values that can be matched to corresponding calibration characteristic values associated with a plurality of conditions associated with system 108 or an associated vehicle (for example, a flat tire, a bulge on a tire, a locked brake, etc.).

During calibration, or training, this image may be employed by a classifier to characterize, or classify, the vehicle conditions and to store those classifications for use during normal sensing operation. In exemplary embodiments in accordance with principles of inventive concepts a classifier may be trained on a vehicle used exclusively for such calibration activities and the models developed thereby downloaded to sensors in the field for sensing operation. Libraries of such models, for different vehicles and different conditions, for example, may be developed and distributed to sensors for operation in the field. For repeatability, the vehicle and conditions used for training the classifier may be substantially similar to the vehicle and conditions using the model in the field for sensing.

Generally, an artificial neural network consists of units (neurons), arranged in layers, that convert an input vector into an output. Each unit receives an input, applies a function, which may be a nonlinear function, to the input and passes the output on to the next layer. Networks are generally defined to be feed-forward. Weightings are applied to the signals passing from one unit to another, and it is these weightings that are tuned in the training phase to adapt an artificial neural network to a problem, the entire process of which may be referred to herein as creating a classifier model. During training, the number of classes desired and the class identification of each training sample is known. That is, for example, if tire failure information is to be determined within one percent accuracy, the number of classes may be set at one hundred, and training data for each of the one hundred levels is presented to the classifier for training. This information, the number of classes and class identification of each training sample is used to determine the desired net output and to compute an error signal. The error signal indicates the discrepancy between the actual and desired outputs and is used to determine how much weights assigned to neurons should be changed to improve the performance for subsequent inputs. Once trained in this fashion, a classifier may respond to an input by providing an indication of which of the classes most closely matches the input.

Analog and digital implementations are both contemplated within the scope of inventive concepts and, although a digital implementation is the focus of the detailed description of exemplary embodiments an analog implementation employing, for example, phase change cells as neurons, or neural nodes, is contemplated within the scope of inventive concepts.

In an exemplary embodiment in accordance with principles of inventive concepts, an artificial neural network model is trained using samples at condition (or degree of failure, for example) of interest. For improved accuracy, even smaller increments may be employed. The number of training samples for each condition may vary widely, from only one to hundreds, depending upon vehicle, condition, and environmental factors, and depending upon the desired resolution. In order to compensate for issues such as background noise, intermittent vibrations, or other environmental factors, a sensor system in accordance with principles of inventive concepts may be trained over a period of time under different circumstances.

Once trained, the classifier model may be stored and used for vehicle condition determination on the same classifier upon which it was developed or the classifier model may be loaded onto another classifier and employed to determine conditions of the same or other vehicles. In this manner, a single classifier may be trained for a given vehicle and associated conditions and the model transferred to a multitude of sensors in the field (for example, thousands of sensors on vehicles distributed throughout the country). The model, or more precisely, model parameters, such as synaptic weights, may be transferred through the cloud, through dedicated networks, such as wide area networks, or local area networks, and may be updated using the same communication link when, for example, more precise models become available or to accommodate a new vehicles, new vehicle components, or new material contained therein, for example.

In exemplary embodiments in accordance with principles of inventive concepts, results may be obtained from a vehicle installation, where vibration may be sampled at 16 kHz for one second, yielding approximately 16,000 data points. This time domain signal may be conditioned and converted, via Discrete Fourier Transform (DFT) into the frequency domain. The frequency domain representation may then be further transformed to a frequency vs time spectrogram. The spectrogram, a frequency vs time image, may then be supplied to a classifier trained as described above. In exemplary embodiments in accordance with principles of inventive concepts, data may then be pre-processed, for example, by performing normalization, feature scaling, and regularization to enhance the accuracy of a sensor system in accordance with principles of inventive concepts. The classifier provides an output indicative of which of the classes, which vehicle condition, the input signal corresponds with.

Experimental results may be obtained using a classifier contained within system 108, but it is contemplated within the scope of inventive concepts that the classifier may be housed on a dedicated server accessed by a sensor unit's communication link. Such a server may be situated “on the cloud” or a dedicated local or wide area network, for example, allowing a sensor system to gather and condition data points and forward the data to a central processor for classification/analysis. In this manner, a system in accordance with principles of inventive concepts may reduce the cost and power consumption of each of the systems 108, allowing for more efficient classification and relatively easy updates on a dedicated and optimized server (such as fleet server 106, for example).

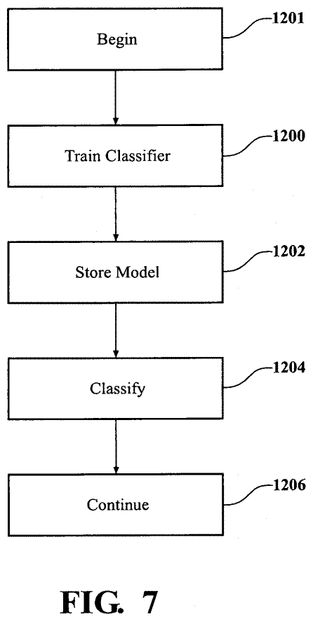

The flow chart of FIG. 7 depicts a method of sensing in accordance with principles of inventive concepts. In particular, the method entails training a classifier to generate a model 700 including correlations to a plurality of vehicle conditions, storing the model 702, and employing a trained model to recognize a vehicle condition 704. In this example embodiment a classifier model is trained with acoustic, or vibrational, data corresponding to acoustic signatures in different vehicle conditions. The model may then be stored on a server, for access by systems 108 in the field, or may be downloaded directly to such systems 108 for use in the field. In exemplary embodiments, a robust model is trained, with various vehicle conditions. Additionally, variations in temperature and other vehicle conditions may be used to train the classifier and, as a result, library models corresponding to various vehicle conditions, such as tire inflation, tire damage, vehicle bearings, load conditions, at various temperatures, etc. may be constructed.

To ensure accuracy, the same mechanism, vehicle, or simulation may be used during training as may be used in the field. Additionally, entries in the model library may be associated with similar vehicle constructions (having similar mechanical properties that generate responses that are similar within a range of responses), similar vehicle construction (size, shape, weight), similar sensor location on a vehicle and similar temperatures.

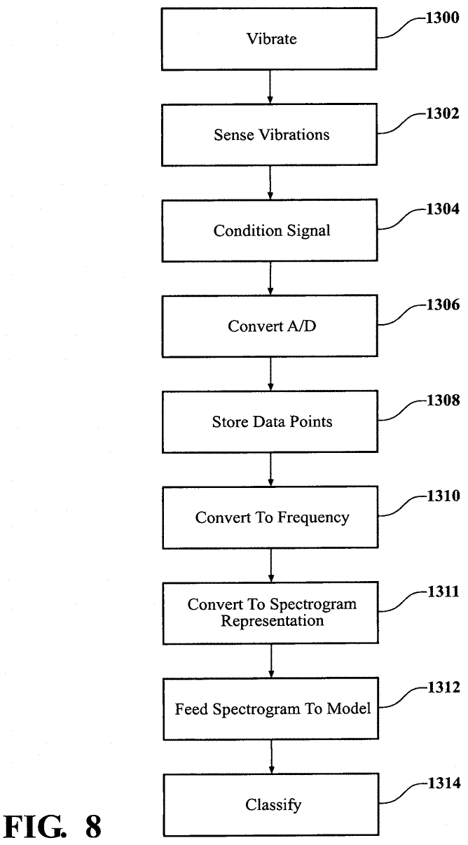

The flow chart of FIG. 8 depicts an exemplary embodiment of “normal” or “field” operation (that is, sensing operation, as opposed to training operation), of an exemplary embodiment of a system 108 in accordance with principles of inventive concepts. The exemplary process begins in step 800, where vehicle conditions, such as road travel, sets up vibrations in the vehicle being monitored, or sensed. Signal conditioning may accommodate a variety of signal levels to, for example, avoid signal clipping or other signal range-related challenges.

In step 802 sensor system 108 senses the vibrations. In exemplary embodiments, the sensor is a three axis accelerometer employing a microelectromechanical (or piezoelectric charge type, for better temperature stability) device, but inventive concepts are not limited thereto and training and operation with any sensor (for example, pressure, temperature, humidity, etc.,) or analytical result is contemplated within the scope of inventive concepts. In step 804 the signal generated by the sensor is conditioned, for example, by filtering and amplification in a two-stage gain amplifier. The resulting conditioned signal is converted from analog to digital form in step 306 and stored in step 308. A number of data points may be collected in this manner. For example, in exemplary embodiments approximately sixteen thousand such data points are collected over the course of one second, but inventive concepts are not limited thereto. The number of data points collected may be reduced or increased, depending upon environmental or design factors, for example.

The conditioned signal from step 808 is then converted from a time domain signal to a frequency domain signal, (that is, from an amplitude versus time signal to an amplitude versus frequency signal) using, for example, a Fast Fourier Transform (or Discrete Fourier Transform) in step 810. The frequency domain signal representation of step 810 is then further transformed into a spectrogram representation in step 811. In step 812 the spectrogram representation is fed to the classifier model to determine the vehicle condition of interest. That is, a classifier model associated with a similar vehicle developed in accordance with principles of inventive concepts is employed by system 108 that accepts input a spectrogram representation developed in step 812 and, depending upon the response of the classifier model, determines the vehicle condition in step 814.

That is, in exemplary embodiments, the spectrogram representation of a vehicle's condition of interest is compared in, or classified by, an artificial neural network classifier, but inventive concepts are not limited thereto. Classifiers and the training thereof are known and described, for example in “Unsupervised Feature Learning For Audio Classification Using Convolutional Deep Belief Networks,” by Honglak Lee, et al, Computer Science Department, Stanford University, published in Proceedings, ICML '09 Proceedings of the 26^{th} Annual International Conference on Machine Learning, pages 609-616, ACM New York, N.Y., USA, ISBN: 978-1-60558-516-1, which is hereby incorporated by reference.

In a tire delamination event, the separation begins when fatigue cracks develop circumferentially at the interface between two steel belts of a radial tire. Generally, there will be a single location on the tire where the cracks develop into a large pocket under the tread. When this pocket is sufficiently large, the tread and outer steel belt will separate from the inner steel belt and form a flap, as illustrated in FIGS. 9 and 10. This flap may be characterized as a leading edge flap (open facing the direction of rotation at the top of the tire) or as a trailing edge flap (closed facing the direction of rotation at the top of the tire). It is believed that the type of flap that is generated is dependent upon a number of factors such as pocket size, vehicle speed, tire temperature, tire load history, tire pressure history, amount of remaining tread, and so on. It is believed that there will be either one or both types of flaps generated in a given delamination event, and that these flaps will result in either a full or a partial delamination of the tire tread.

Tires are used on vehicles and trailers for highway applications with controlled and predictable road conditions and for off-road service applications with highly variable operating conditions. The factors that affect tire life and unhealthy conditions can be presented in various categories such as: vehicle loading; vehicle speed; tire-truck/trailer interaction due to truck/trailer load; truck/trailer size; speed; wheel position, as steering or driven; tire-road interaction, such as curves, grades, elevations; friction; temperature; road surface profile; tire-maintenance interaction, such as tire alignment; tire rotation; tire air pressure; tire temperature; preventive maintenance; and tire-environment interaction such as weather, temperature, snow or rain. Tires are removed from service for various reasons, including: cuts or separations in the tread; cuts or separations in the shoulder; cuts, separations, radial splits, in, or road shoulder collisions with, a sidewall; separations, flange erosion, cracking or installation errors related to the bead; and splits in, lifting of, or wrinkles in the liner.

The forces on a wheel during a tire separation or delamination are principally vertical and longitudinal in nature. The longitudinal forces will be generated from the retardation of the rotation caused by impacts of the tire flap with the fender and other body parts while rotating. Such impacts result in wheel-braking. The effects on the retardation of the vehicle cannot exceed the coefficient of friction of the tire interface with the pavement. That interface will most often be the steel belt on the carcass from the tire and the pavement. The friction at that interface is around 50% of the normal friction between the tire and pavement. The cyclic vertical component of forces is generated due to the imbalance of the tire caused as sections of the tire tread are separating from the cords. The tread flap and remaining tread cause significant imbalance in the tire and can experience up to 250 G's while turning at highway speeds. The magnitude of the vertical force will be affected by: the weight of the attached tread and its radius from the axle, the weight of the detaching flap and the radius of the center of gravity of the flap from the center of rotation, and the rotational speed of the wheel.

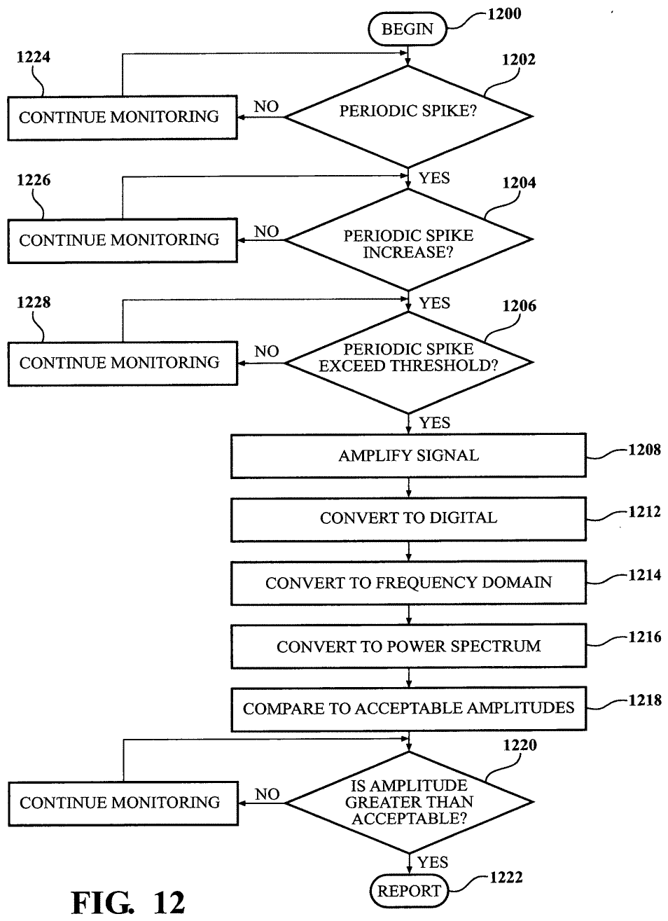

Studies have demonstrated that the response of the axle from a single tread section encompassing ½ of the tire causes a sudden growth in response as the harmonic frequency of the axle/tire-spring system are approached. However, instead of the response decreasing after the area of harmonic frequency is passed as the speed increases, the response shows a slight decrease then continues to grow, as illustrated in FIG. 11. This continued growth in response is due to the increase in force from the dynamic imbalance increasing as a square of the velocity of the tire.

As the high side of the harmonic frequency band is reached, the tire force has grown sufficiently to continue to drive the tramp motion of the axle. Tramp motion is a vertical vibration of the front axle accompanied by a small degree of simultaneous oscillation of the wheel assembly about the king pin. For an under damped axle system, cyclic tramping motion will continue 10 to 15 Hertz beyond the band associated with the harmonic frequency. For example, a mere 15 cm (6 inch) section of tire tread weighs 1 kg (2.2 lb). At 80 kph (50 mph) this section of tire tread will generate 1.23 kN (277 lb) of cyclic force. At 112 kph (70 mph) that same piece of tread will generate 2.42 kN (544 lb). While the tire is delaminating, the section of tread will begin as a 244 cm (8 foot) long section of rubber and steel and begin to decrease in size in an unpredictable manner throughout the process of delamination. Thus, there is significant potential for large cyclic forces on the order of 4478 N (1000 lb) to be generated during delamination. Studies indicate that the destabilizing forces generated during the delamination of a tire will be from the imbalance of the tire due to the section of tread remaining on the tire. Until the tire is clear of tread (that is, all tread has been, dangerously, thrown off the tire) the tire will likely continue to cause tramping if it is rotating at or above the harmonic frequency of between 10 and 15 Hertz.

Although, in example embodiments described herein a system may be self-powered, as, for example, the wheel-end systems described in parent applications incorporated by reference herein, inventive concepts are not limited thereto. In example embodiments that include a self-powering, or, simply, a power generating system, the power generating system, as described in greater detail in parent applications incorporated by reference herein, may generate power in conjunction with wheel/tire rotation and may, at the same time, continuously transmit and monitor wireless sensor values, such as accelerometer values. As previously noted, constant power generation allows for high speed continuous sampling of sensor data (i.e.: in the range of many thousand or tens of thousands of samples per second) to allow not only time domain analysis (i.e.: counting of events), but also frequency analysis, which gives richer data for signal analysis and the ability to incorporate image recognition and machine learning using the acquired data. Sensor signals obtained in an active mode may be indicative of acceleration values within a normal range of operation and also may detect acceleration values outside a “normal”, that is, preferred or preset, operating range. On-board, active signal processing and analysis in accordance with principles of inventive concepts allows accurate prediction of the health of a tire and the onset and presence of early delamination indications.

In example embodiments a monitoring system may be attached to a wheel-end hub and energy may be generated through rotation of the tire as the associated vehicle moves. The monitoring system may be configured to transmit raw or processed acceleration data, along with the identification of the corresponding tire, for example. A monitoring system in accordance with principles of inventive concepts may be configured to compare acceleration signals from different tires on the same vehicle. By employing data from various wheel-end sensors on a vehicle, a system and method in accordance with principles of inventive concepts may ensure that the data gathered is “local” (that is, attributable to the specific wheel-end sensors), and not environmentally generated (that is, not due to a phenomenon to which the entire vehicle is subjected). By comparing sensors from opposite sides and at different positions along the length of a vehicle in this manner, a system and method in accordance with principles of inventive concepts may more readily detect an anomaly related to a specific wheel-end, or tire, rather than reacting to an environmental event that may generate “false positive” responses for all the tires on a vehicle. In example embodiments, a system may employ data from a variety of sensors to determine a plurality of properties of the tire and the wheel end assembly. Additionally, the monitoring system may transmit the raw, pre-processed, reduced, or analyzed acceleration data and alert an operator or other responsible party (for example, a dispatcher or fleet maintenance personnel) when an incipient tire anomaly is detected. In example embodiments, a system may monitor the upper and lower ranges of the accelerations from the various wheel/tires and comparing them to preset acceleration values. When acceleration values fall outside the predetermined ranges, the operator, or other responsible party, is notified by the monitoring system via alarms sent, locally, to a driver through a cellular phone and/or to a dash display or, remotely, through a cellular network, through a WiFi connection, through radio communications, through a telematics system (OnStar® or Verizon Hum®, for example) or other means, to other responsible parties, such as dispatch or fleet maintenance personnel or a user's maintenance facility, such as a dealership. For example, at 60 mph a typical truck tire will be rotating 440 times per mile or, 7.3 times per second. If a delamination point is localized to one spot on a tire, an indicia of tire defect (for example, increased three-axis acceleration amplitude related to impending delamination) should be prominent at a frequency of 7.3 Hz. The magnitude of the indicia would yield to the system the severity of the defect. In example embodiments, accelerometer(s) continuously monitor the vibrations of the wheel end assembly and tire, regardless of the source of the vibrations. If the wheel is out of balance or deteriorating due to initial tread and belt separation, or if there is excessive wear of any suspension component, the abnormal resulting vibrations or accelerations will be sensed by accelerometer(s), which may be included within the electronics of an energy harvesting unit in example embodiments.

In example embodiments a system in accordance with principles of inventive concepts may be implemented as, or may include a subsystem, referred to herein as an intelligent wheel end assembly (I.W.E.A.) that may include a plurality of wheel-end units, each of which is attachable to the hub of the wheel-end of a wheeled vehicle. In example embodiments, because they are more likely to be subjected to similar environmental conditions at approximately the same time, wheel-end units attached to opposite wheel-ends of the same axle may be paired up for comparisons, as described in greater detail below. Such a pair of wheel-end units, with internal and/or external controllers or processors may be referred to herein as an intelligent wheel end assembly (IWEA). In similar fashion, a wheel end may be paired up for comparisons with wheels on the same side of the vehicle that are ahead of (preceding) or behind (lagging) a similar wheel end.

A system in accordance with principles of inventive concepts may monitor sensor readings and may analyze the readings to diagnose conditions related to vehicle components, including tires, axles, bearings, or components of the monitoring system. The system may analyze readings to predict, or prognosticate, conditions related to vehicle components or to components of the monitoring system, or even external environmental factors, such as road conditions. Each wheel-end unit may include a communications interface for communications, as noted above, for communications, for example, among wheel-end units associated with a vehicle monitored by the system. Processing and analyzing tire acceleration and, optionally, rotational, temperature, pressure, or other signals, allows a system in accordance with principles of inventive concepts to detect defect(s) and their associated location(s), such as bead, upper and lower sidewalls and, especially, tire tread and belt plies separation.

Additionally, prediction models used for damage diagnosis based on optimized number and location of a single or multiple accelerometers in the IWEA may be developed in accordance with principles of inventive concepts. A sensor package that provides multiple channels of acceleration data may be employed to provide a “sanity check” (that is, as a means of verifying) for a dedicated accelerometer, for example. In example embodiments, a system in accordance with principles of inventive concepts may employ an inertial measurement unit, which may provide: multiple (e.g., ten) degrees of freedom, including three axis acceleration, three axis gyroscope, three axis magnetometer and one temperature sensor. In example embodiments, the radial component of the acceleration signal(s) may prove particularly useful in tire defect detection and may be preferred if only one of the radial or circumferential acceleration signals is used.

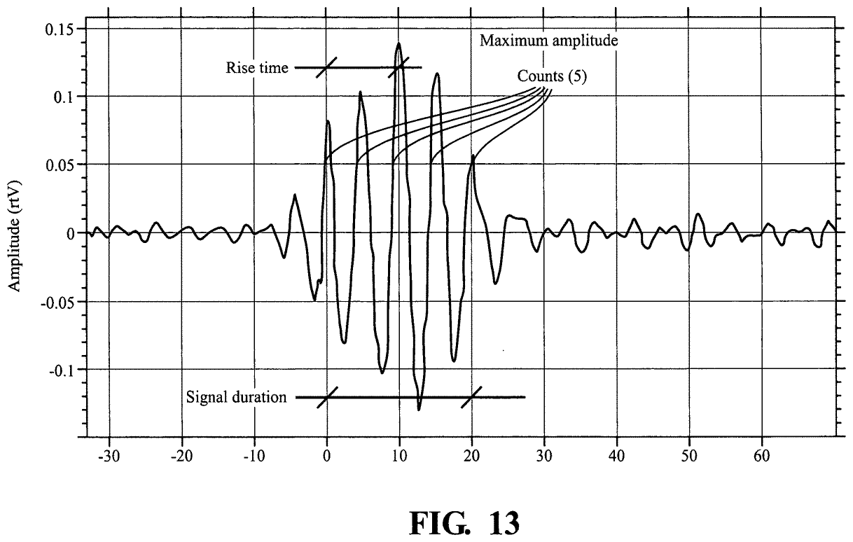

The flow chart of FIG. 12 illustrates an example process of performing tire diagnostics, prognostics, and health monitoring in accordance with principles of inventive concepts. In this example embodiment, measurements, analysis, diagnoses, predictions are related to an IWEA that includes a pair of wheel-end units, one each for each wheel-end of a vehicle axle. In example embodiments, systems in accordance with principles of inventive concepts would include a plurality of IWEAs: one for each vehicle axle. The process begins in step 1200 and proceeds to step 1202 where radial acceleration data is gathered for each wheel-end in an IWEA. The data may be assessed for periodic signals, such as acceleration peeks that correspond to the period of rotation of an associated tire, for example. A signal amplitude beyond a threshold value may be indicative of the onset of a tire defect such as impending delamination, for example.

From step 1202 the process proceeds to step 1204, where the example system and method determines whether a periodic spike is present in any IWEA associated with the vehicle. A periodic spike, a sensor value (for example, and acceleration value), outside a threshold range that occurs with a period correlated to a tire rotation, may, as indicated above, signal an tire defect, such as an impending delamination and a system and method in accordance with principles of inventive concepts may monitor such spikes to detect the onset and/or progress of a tire defect. If a periodic spike is detected in any IWEA, the process proceeds to step 1206, where the system determines whether the detected periodic spike is increasing in amplitude and, if it is, the process proceeds to step 1208, where the system determines whether the periodic spike exceeds either an upper or lower threshold amplitude value. As previously indicated, signals, particularly anomalies such as spikes, associated with one IWEA may be compared to signals from other IWEAs to ensure that the anomaly is not a “false positive.” In example embodiments, spike detection may be employed as a preliminary screening process to limit the amount of processing required of the system and method. That is, rather than continuously performing all the processing (FFTs etc.) on all the data that is received and making a determination as to whether a delamination event is about to occur, in example embodiments a system in accordance with principles of inventive concepts may first search for signature events, such as an acceleration signal spike, that may be used as a trigger to then do further, deeper, analyses. If the periodic spike falls outside the range of acceleration amplitudes, the process proceeds to step 1210, where the signal is preprocessed (for example, amplified, scaled, filtered, etc.). In example embodiments, the spike signal may be accumulated and analyzed over a plurality of tire rotation cycles. In step 1212 the pre-processed signal is converted to a discrete time digital signal. In example embodiments a system in accordance with principles of inventive concepts may employ a digital accelerometer, which provides the digitization, pre-processing, level-shifting, etc., and which may relieve an in-system processor of the digitization workload. After discretization in step 1212, the process moves to step 1214, where the digital signal is converted to a frequency domain signal and, from there, to step 1216, where the frequency domain signal is converted to a power spectrum of amplitudes at different frequencies. In step 1218 the process compares amplitudes of different frequencies to acceptable amplitudes from another IWEA, for example, associated with a wheel-end on the opposite end of the same axle as the processing IWEA. As previously indicated, such comparison may be employed in example embodiments to screen out “false positive” results. If the amplitude of different frequencies falls outside the range of amplitudes the process proceeds to step 1220, where the exceedance is reported, through any of the communications channels previously noted. In steps 1204, 1206, 1208, and 1218, if the decision is negative, the process returns to continue monitoring signals, as indicated in steps 1224, 1226, 1228, and 1230, as indicated in the flow diagram.

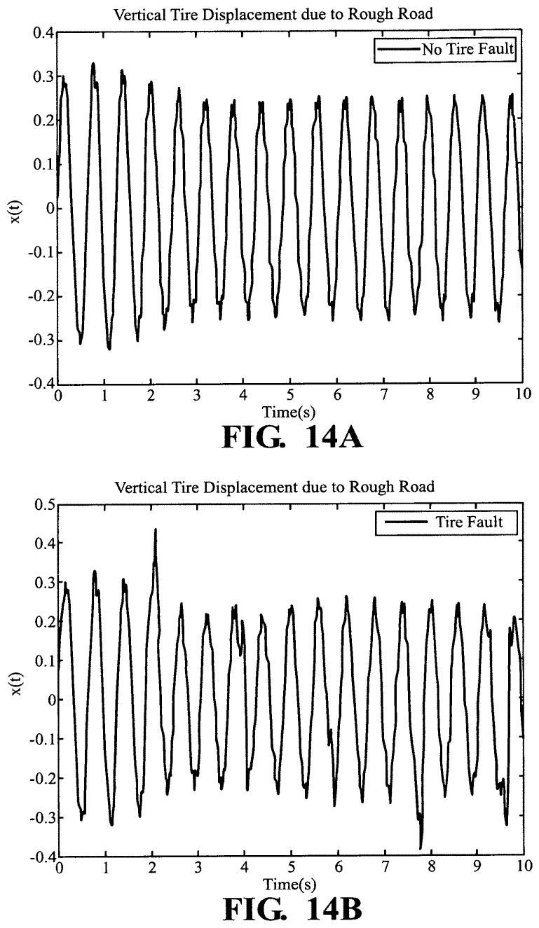

In example embodiments a system and method in accordance with principles of inventive concepts may employ an examination of the number of counts that are considered in the time domain as an indication of impending tire failure/delamination. As illustrated in the screen shot of FIG. 13, a sample of high energy impact, or acceleration, may be monitored. In this example embodiment, the number of counts of the signal duration rises rapidly from 0 to 20 in the center of the graph when the area of impact generation is reached. Under these conditions it may be possible for a system in accordance with principles of inventive concepts to detect critical impacts indicative of the initiation of tire tread separation. For example, with five counts outside the background “norm” of the signal, a system may relate such a signal to a delamination event (which may include the onset, propagation, or other stage in a delamination) and may use such a signal to isolate such an event and focus on a particular tire location for further analysis, for example using a classifier. In example embodiments, a system and method in accordance with principles of inventive concepts may employ other indications of tire and wheel-end assembly “health” (that is, the condition of the tire and/or wheel-end), such as whether there is unbalance in the system. Unbalance can cause excessive forces that affect the performance of the wheel-end and, consequently, an associated vehicle.

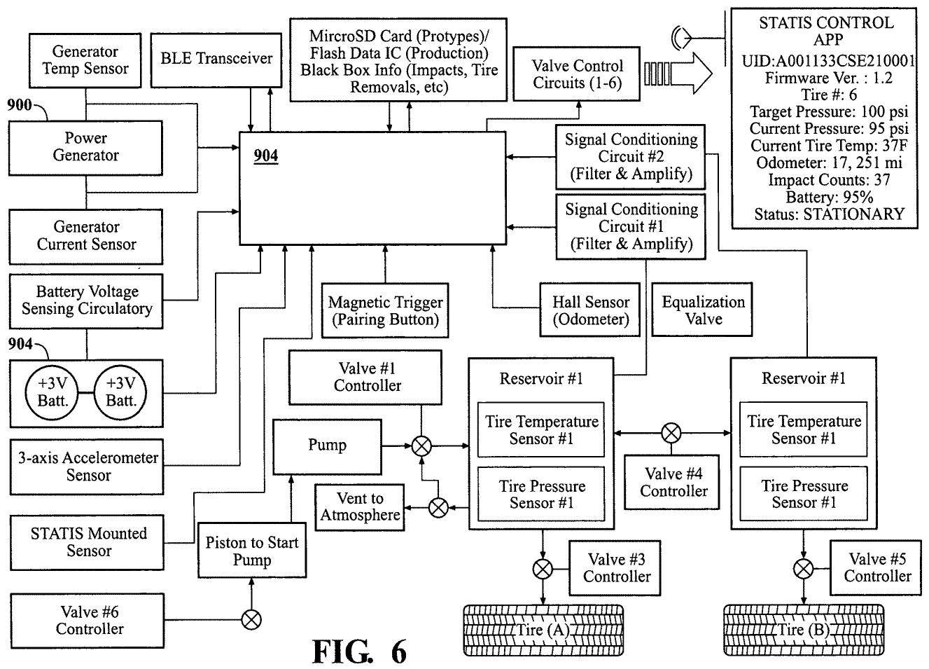

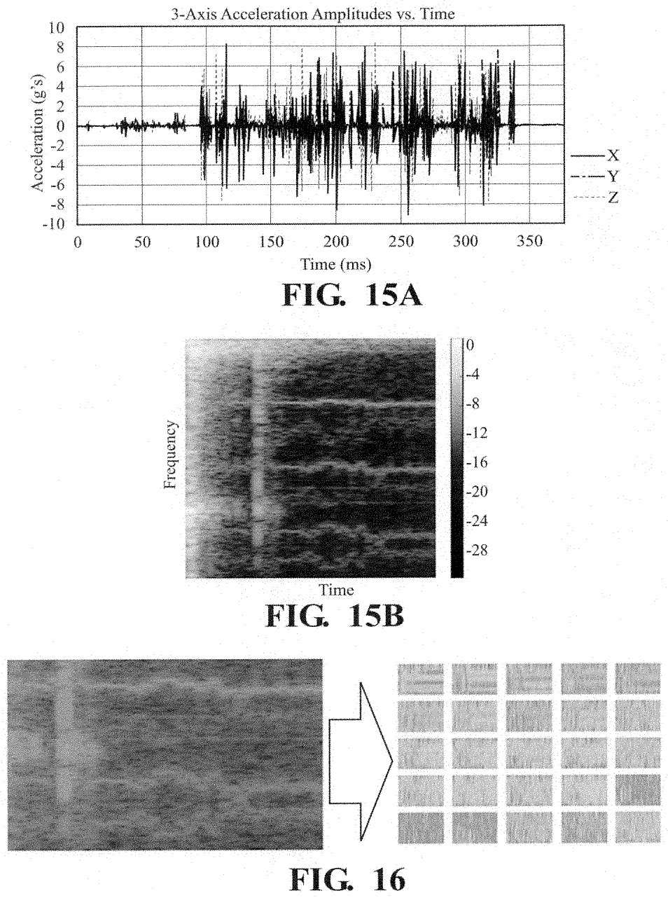

Unbalance may be characterized by the mass centerline of an object (for example, a tire, or wheel-end) not coinciding with the object's geometric centerline. In general, there are two types of non-static unbalance: coupled and dynamic. Static unbalance may be measured with the object (for example, a tire) at rest, but, unlike static unbalance, coupled unbalance cannot be. With coupled unbalance, two equal forces (weights) are 180° from each other, which causes the tire to appear to be balanced while it is at rest. However, when the tire rotates, these forces move the tire in opposite directions, at their respective ends of the axle. This causes the tire to wobble, which produces a 180° out-of-phase tire displacement reading (FIG. 6 and FIG. 7) from opposite end of the axle. Such readings are illustrated, for example, for a balanced tire in FIG. 14A and for an unbalanced tire in FIG. 14b. Dynamic unbalance is the combination of static and coupled unbalance. On simple machines, there is usually more static unbalance than coupled unbalance. On more complex systems such a wheel-end assembly, with more than one coupling or several areas on the tire where unbalance can occur, coupled unbalance is usually more prominent.

A system and method in accordance with principles of inventive concepts may employ signature vibration characteristics to detect nascent tire or wheel-end faulty conditions, such as unbalance. Signature vibration characteristics may include: a single frequency sinusoidal vibration whose amplitude is the same in all radial directions; the vibration is cyclical, occurring at a frequency of once per revolution of the tire; and the spectrum generally does not contain harmonics of the tire revolution frequency. In severe cases, with extreme unbalance, the vibration amplitude increases with speed. That is, generally, a tire unbalance will show a specific signature (e.g., acceleration amplitude profile) that remains constant over a long period of time or a high number of tire rotations. However, if this acceleration amplitude increases, this may be indicative that and additional and different condition, such as the initial stages of tire delamination, is being detected and a system and method in accordance with principles of inventive concepts may employ such longitudinal monitoring to identify, further analyze and report on (e.g., set an alert) such events. For example, a road event such as a pothole could cause a wheel deformation which could result in a periodic wheel imbalance in the acceleration signatures. This could manifest itself in a periodic in the acceleration plot. This periodic perturbation would remain unchanged over time.

Another road event could possibly result in a local ply delamination and/or local ply belt damage that over time may continue to delaminate and separate from the carcass. This progressive change in tire health state could still be periodic, in that the defect would continue at an approximate radial position on the tire, but could expand in the amount of delamination of the ply from the carcass and the amount of ply cord fatigue, resulting in a change in the accelerometer signature.

In the early stages of tire degradation due to impending tread separation, a tire defect may not be detectable on simple acceleration or velocity vibration spectra. This is due, in part, to the fact that the vibration present in the tire frequency range may not be shown by the vibration FFT (Fast Fourier Transform) and/or the vibration's amplitude may be so small that low frequency rotational vibrations mask it. To accommodate such potential difficulties, a system in accordance with principles of inventive concepts may employ acceleration enveloping measurements that monitor tire frequency ranges at which the defect's repetitive impacts occur. The system filters out nonrepetitive impact signals, such as low frequency rotational events and the repetitive impact signals are enhanced and appear as peaks at the defect's frequency. To assist in determining whether a tire's defects include a faulty tread or cord, tire defect frequencies can be calculated and overlaid on the vibration spectra. In example embodiments, combining wheel type (which may yield wheel dimensions such as circumference and width of the tire), wheel speed in the direction of travel, and the frequency of acceleration events (e.g., spikes) that correspond to defects that may lie below the surface of a tire, allows a system and method in accordance with principles of inventive concepts to map out the tire location(s) corresponding to the acceleration event(s). With this map, the system may determine where the subsurface faults (manifested by vibrational signals as the tire location of interest contacts a road surface) occur, along the circumference of the tire (along the entire circumference or a portion thereof, for example) and/or across the width of the tire (across the entire width or a portion thereof, for example). Once these determinations are made, the system may transition from a frequency analysis to analyses employing one or more trained classifiers that may differentiate between different failure modes (referred to herein, for example, as a first or second type of delamination).

In an example embodiment the system may obtain information regarding a vehicle's tire type, through a user interface, for example. Given the tire type (280/85/R28 in this example) the system can determine (for example, from a table lookup) the diameter (46.7 inches) and circumference (approximately 12.23 feet). The system may determine the speed of the vehicle by calculating the rotation of a Hall sensor mounted in a wheel-end unit. Assuming the system determines, in this or another manner (for example, communications from the vehicle's speedometer), that the speed of the vehicle is 60 mph. The system many then sample the sensor data (for example, accelerometer data) at a sufficiently high rate (5300 Hz in this example) to detect frequencies up to a Nyquist frequency, in this example, of 2650 Hz. The system may determine that, with a speed of 60 mph and circumference of 12.23 feet, the tire is rotating at 7.2 times per second and, as a result, the system is monitoring for accelerometer data with distinguishable features, such as peaks, at a frequency of 7.2 times per second and mapping those features onto the tire. If, for example, the distinguishable features map to an area of one foot in length, the system may determine that the corresponding localized area may be include a defect, such as a nascent tire delamination. The system may then monitor this area more diligently in order to more precisely locate and predict any defect, such as a tire delamination, that may occur. Once an area of heightened interest is detected, once the system determines that a defect may be developing in a particular area of a tire, the system may turn to machine learning, converting the frequency data to one or more spectrograms and then running the spectrograms through a classification process, employing a library of trained classifiers that have been trained on a plurality of defect types, for example.

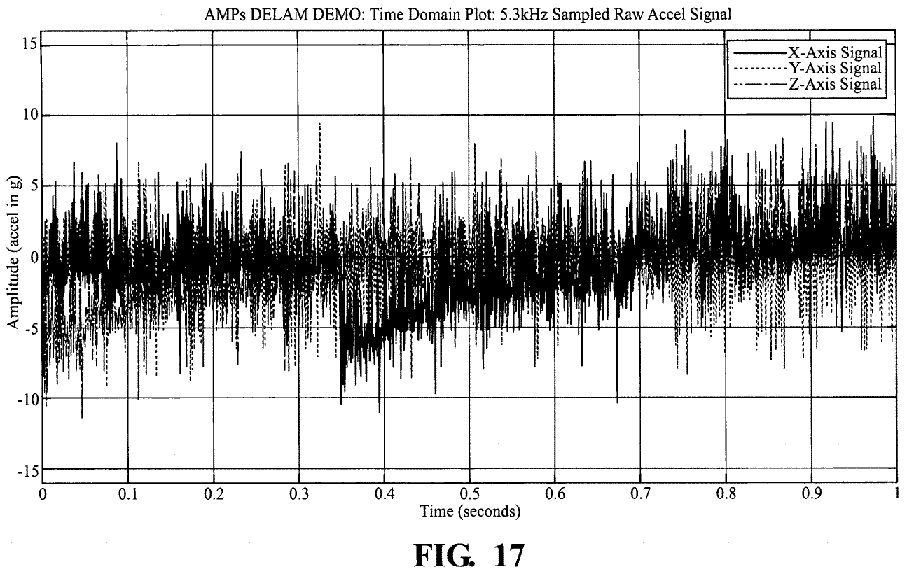

In an example embodiment defects may be determined by transforming time domain accelerometer readings, as illustrated in the 3-axis acceleration plot of FIG. 15a, into a power spectral density plot (PSD) with a time/frequency representation, such as that of FIG. 15b, using, for example, an FFT. A time/frequency signature provides a richer representation of the original signals and a time/frequency representation image of the signal can be used to generate a feature vector, which may be used to train classifiers used for delamination prediction in accordance with principles of inventive concepts.

Signals seemingly indistinguishable in the time or frequency domain may be easily distinguishable in the joint time/frequency domain. In example embodiments a time/frequency representation(s) of a tire(s) with a known amount(s) of delamination may be employed to train a classifier and the trained classifier may then be used to detect tire delamination on vehicles in a working environment.

In example embodiments, due to the complexity associated with working with a time/frequency domain image such as that of FIG. 15b, the process may ease computational burdens by recognizing that the spectrogram includes a large number of elements, many of which are redundant and, in example embodiments, may be discarded. As is known, in signal processing the two most commonly used filters are Finite Impulse Response (FIR) and Infinite Impulse Response (IIR) filters and FIR filters may be designed from IIR filters using various techniques. One technique is a window technique, which may be employed in example embodiments in accordance with principles of inventive concepts. That is, in example embodiments a window technique is used to reduce redundant data to make the processing and analysis of collected data more feasible, more focused and more rapid. Any of a variety of windows, such as a “Blackman Window,” “Hamming Window,” or a “Boxcar Window,” all known in the art, may be employed to “clean up” (that is, reduce extraneous data, for example) spectrograms in accordance with principles of inventive concepts.

In example embodiments, using linear algebra techniques the process determines an optimal set of basis images onto which the raw spectrogram data is projected. In example embodiments, employing machine learning, a system and method in accordance with principles of inventive concepts may employ machine learning, in which process the system and method selects a trained model for comparison to spectrogram data. In example embodiments a system and method in accordance with principles of inventive concepts may employ a variety of trained models in a classifier library, such as a “delamination classifier for class 8 vehicle with standard tires,” or a “damaged tire” model, or a model for a “sports car with high performance tire,” with each model or grouping of models allowing for more precise detection of faults, such as tire delamination. In example embodiments a data set is arranged as a matrix loaded with spectrograms developed from vehicle data, as previously described. In example embodiments, a system may perform operations on this matrix of spectrograms, such as cropping, scaling, shearing, etc., employing matrix operations common to linear algebra. In example embodiments the classification categories created and employed by a system in accordance with principles of inventive concepts may be encoded into vector tables for ease of processing. For example, classifications of 0%, 10%, 20% . . . 0.10% delamination may be entered in a table as follows:

$$0 \% \text{:} 1 , 0 , 0 , 0 , 0 , 0 , 0 , 0 , 0 , 0$$

$$10 \% \text{:} 0 , 1 , 0 , 0 , 0 , 0 , 0 , 0 , 0 , 0$$

$$20 \% \text{:} 0 , 0 , 1 , 0 , 0 , 0 , 0 , 0 , 0 , 0 \\ . \\ . \\ .100 \% \text{:} 0 , 0 , 0 , 0 , 0 , 0 , 0 , 0 , 0 , 1$$

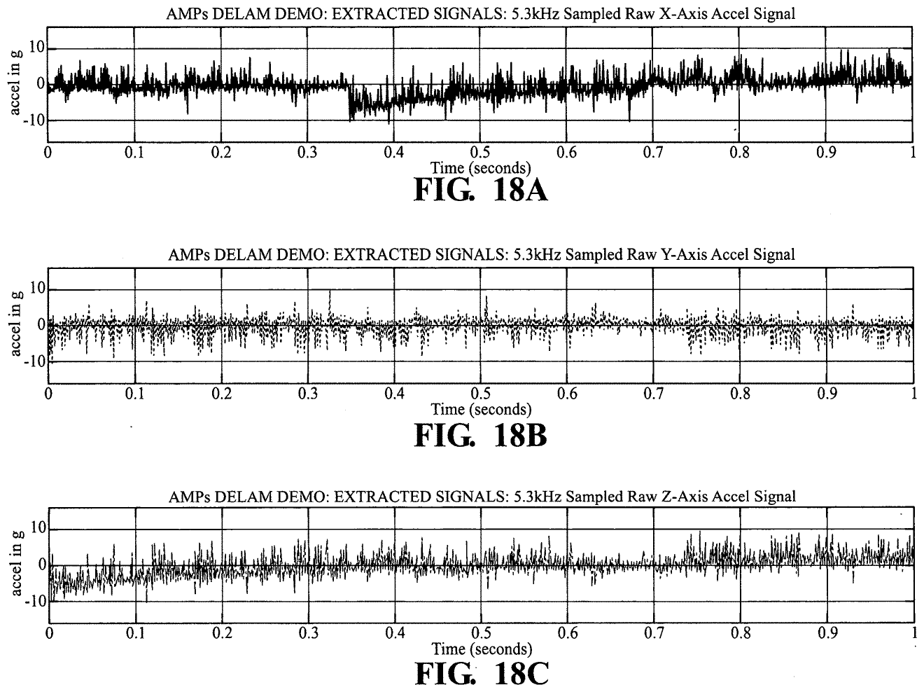

In example embodiments a system may employ linear regression in the modelling to determine as set of coefficients that, when multiplied by each of the input variables and added together, yields the best prediction of a desired output variable. In example embodiments a system may employ “whitening” to filter a data set. For example, a matrix factorization method, such as Principle Component Analysis (PCA) may be used to filter out noise from a data set, as it will automatically reduce the number of columns in a data set. As illustrated in FIG. 16, the spectrogram is projected onto the basis images to generate a smaller, multi-dimensional (twenty-five in the current example) representation of the image. The multi-dimensional vectors can be matched against a library of trained classifiers that have previously been developed using delamination measurements and, should a current image prompt a sufficient response to a trained classifier, the vehicular component (e.g., tire) prompting that response is deemed to be in a state of delamination. The system may determine an onset of delamination and growth of the delamination area by continuing to monitor, transform, and test vibration information against trained classifier(s). The system may employ Monte Carlo simulations, for example, to estimate, with a high degree of accuracy, the degree of delamination from acceleration signatures. As is known in the art, Monte Carlo simulations may be employed to estimate a fixed parameter by repeatedly generating random numbers. By taking the random numbers generated and performing some computations on them, Monte Carlo simulations provide an approximation of a parameter, where calculating it directly is impossible or impractical. In example embodiments a system may employ a Markov Chain Monte Carlo method (MCMC, an iterative process to make a probabilistic update to predict a future state) to generate samples to fill in the partial picture generated by the system's gathered data set, while using a mechanism to ensure that the process focuses more time in the most important regions of the data set. With sufficient data, the process transitions from classification mode to regression, allowing the system to predict and report the exact state of delamination, from onset to complete separation. That is, in example embodiments, as more data is acquired and classifiers trained, greater precision may be obtained with linear regression employed to categorize data sets associated with states intermediate to existing classifiers (for example, a delamination state of 15% associated with classifiers of 10% and 20%).

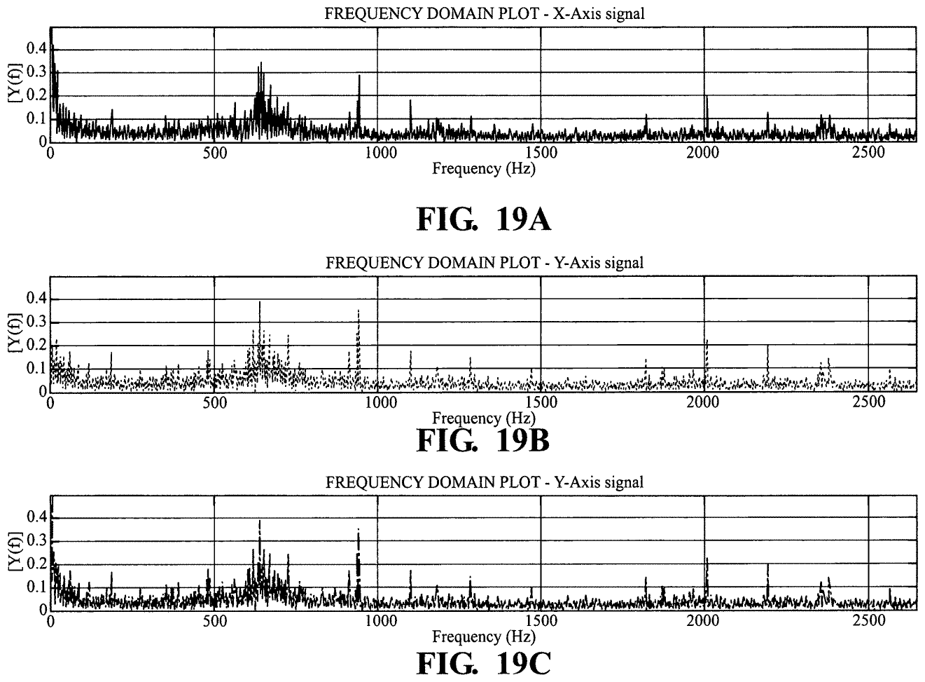

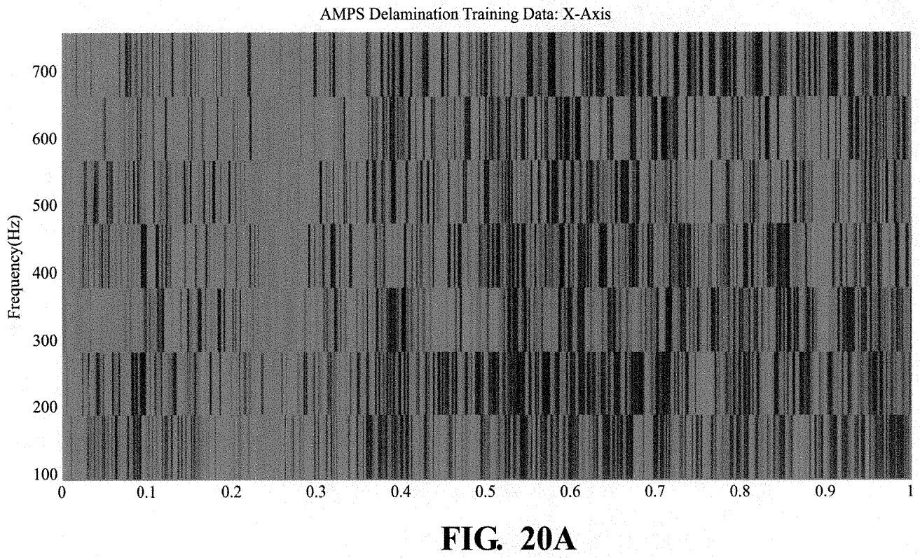

Turning now to FIG. 17, an overview of an example embodiment of system operation will be described. FIG. 17 is a time/amplitude three-axis acceleration plot employing, in this example embodiment, 5.3 kHz sampling and with acceleration in G forces. The time/amplitude data is stored in an array and then the data from each axis may be separated, as illustrated in the time domain plots of FIGS. 18a, 18b, and 18c. The system, with the knowledge of the sampling rate and corresponding sampling time steps (approximately 187 microseconds in this example) may add another column of data in the array: that of time. That is, in example embodiments data may be stored into a matrix, or array, with, for example, column A being the X-axis raw data sampled over the course of one second at 5.3 kHz, column B the Y-axis data, column C the Z-axis data, column D the time, 5300 steps corresponding to all the data. Additional columns may include for pressure, temperature, etc. Given this matrix, the system may perform linear algebraic operations upon it, as previously described. This yields time and amplitude (in G forces). In this example embodiment, the process is sampling 5300 Hz and because data may be extracted at ½ the sampling frequency, signals are detected up to 2650 Hz.

Systems and methods in accordance with principles of inventive concepts are not limited thereto, but for a truck tire application, for example, this sampling rate has been found to be sufficient. That is, with a truck tire circumference of approximately twelve feet, the tire rotates approximately 440 times per mile and, at sixty miles per hour, approximately 7.3 times per second and sampling at 5300 Hz is more than adequate to obtain the desired data, but systems and methods in accordance with principles of inventive concepts are not limited to rates described in example embodiments.

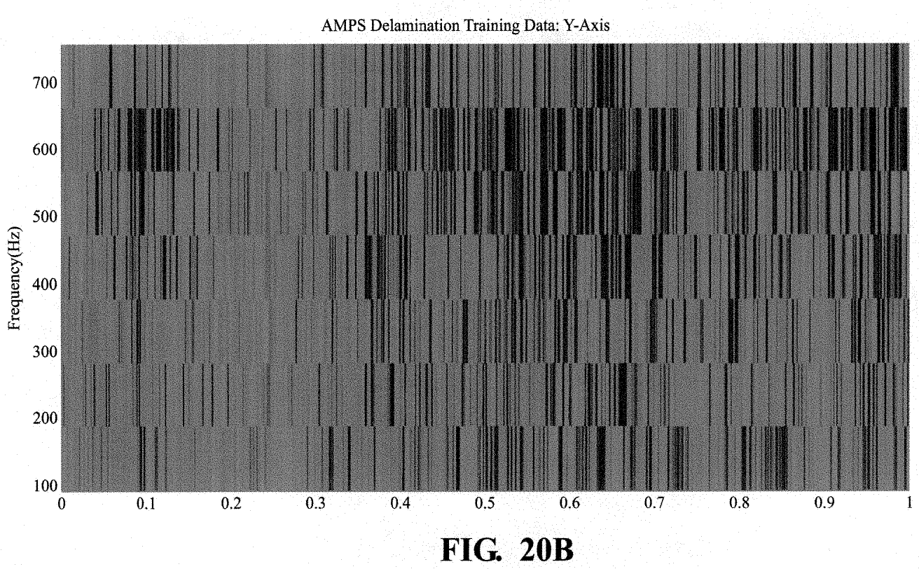

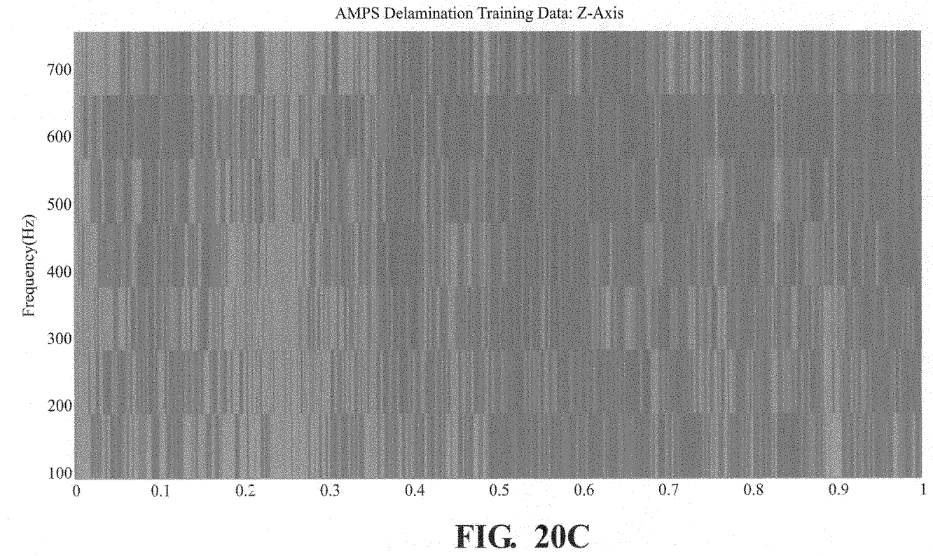

Having derived the time domain data, the system may perform a transformation, such as an FFT, on the data set to obtain frequency domain data, as illustrated in the plots of FIGS. 19a, 19b, and 19c. The system may then perform a transform, such as a Gabor transform, to yield time/frequency spectrogram plots, as illustrated in FIGS. 20a, 20b, and 20c. In example embodiments, these images are used in conjunction with image recognition processing to, first, train classifiers and develop a classifier library and, for “live” on the road vehicle operation, to detect tire or wheel-end defects.

In example embodiments, to reduce processing requirements, each spectrogram image (for example, FIGS. 20a, 20b, and 20c) may be filtered and then subdivided into smaller sub-images: twenty-five sub-images in an example embodiment. This is the windowing filter process described above.

Each of the sub-images may then be employed to train classifiers that may be employed to detect tire/wheel-end defects. For example, each sub-image may be converted into matrixes of numbers to train a classifier. That is, in example embodiments a classifier operation works on vectors, matrices, and tensors and, therefore, to process a spectrogram image, the process converts the spectrogram image into something the process can operate upon. To visualize, imagine that every pixel on a spectrogram is represented by three values—red, green, and blue. Each pixel on the spectrogram may, therefore, be converted into a multidimensional array and stored and manipulated as needed in accordance with principles of inventive concepts. The classification process may include collecting data (for example, three-axis acceleration data) on tires in known states of deterioration, such as at various stages of delamination and employ that data to train classifiers and develop a classifier library. With, for example, a large sample of tires at each of twenty different stages of use/deterioration, from relatively new retreads to retreads at the point of failure, may be used to train classifiers. As previously indicated, with an increasing volume of data, an increasing number of classified states may be developed, with accompanying linear regression and a concomitant increase in prediction precision and certainty. In example embodiments a large number (for example, 100,000) of spectrogram images may be gathered for each of, in example embodiments, twenty, delamination states. After gathering the data and transforming it into spectrogram images, the spectrogram images may be filtered (as previously described) and subdivided for ease of processing. In example embodiments, each spectrogram image may be subdivided into 5×5 images or any other number of sub-images that reduces the processing burden. If the processing power available is sufficient, the spectrogram images need not be subdivided, but eases processing burdens in any case. Both approaches (subdivided or not) are contemplated within scope of inventive concepts. In example embodiments, with 100,000 images at each of twenty delamination states ready to filter and divide into 5×5 images, a portion, 75% for example, of the training data may be used to train classifiers for each of the twenty delamination states. The other portion of the data, 25% in this example, may be used to validate the classifiers, once trained.

While the present inventive concepts have been particularly shown and described above with reference to example embodiments thereof, it will be understood by those of ordinary skill in the art, that various changes in form and detail can be made without departing from the spirit and scope of inventive concepts as defined by the following claims.

What is claimed is:

1. A system for monitoring vehicle performance, comprising:
a sensor configured to sense a characteristic of a vehicle to produce data related to the characteristic; and
a controller to collect and analyze data related to the characteristic of the vehicle, wherein the controller is configured to employ machine learning in the analysis of the data related to the characteristic of the vehicle.

2. The system of claim 1 further comprising a controller to develop and store a library of classifiers related to a vehicle characteristic.

3. The system of claim 1, wherein the vehicle characteristic is related to a vehicle tire.

4. The system of claim 3, wherein the vehicle characteristic is tire pressure.

5. The system of claim 3, wherein the vehicle characteristic is tire temperature.

6. The system of claim 3, wherein the vehicle characteristic is acceleration of a wheel-end associated with the vehicle.

7. The system of claim 1, wherein the system includes at least one optical sensor.

8. The system of claim 3, wherein the controller is configured analyze the sensor data and to make a determination regarding the potential delamination of a vehicle tire.

9. The system of claim 8, wherein the controller is configured to produce an alert related to the potential delamination of a vehicle tire.

10. The system of claim 9, wherein the controller is configured to transmit an alert related to the potential delamination of a vehicle tire.

11. A method for monitoring vehicle performance, comprising:
a sensor sensing a characteristic of a vehicle to produce data related to the characteristic; and
a controller collecting and analyzing data related to the characteristic of the vehicle, wherein the controller employs machine learning in the analysis of the data related to the characteristic of the vehicle.

12. The method of claim 11 further comprising a controller developing and storing a library of classifiers related to a vehicle characteristic.

13. The method of claim 11, wherein the vehicle characteristic is related to a vehicle tire.

14. The method of claim 13, wherein the vehicle characteristic is tire pressure.

15. The method of claim 13, wherein the vehicle characteristic is tire temperature.

16. The method of claim 13, wherein the vehicle characteristic is acceleration of a wheel-end associated with the vehicle.

17. The method of claim 11, wherein data from at least one optical sensor is employed in the analysis.

18. The method of claim 13, wherein the controller analyzes sensor data and makes a determination regarding the potential delamination of a vehicle tire.

19. The method of claim 18, wherein the controller produces an alert related to the potential delamination of a vehicle tire.

20. The method of claim 19, wherein the controller transmits an alert related to the potential delamination of a vehicle tire.
